(19) United States
(12) Patent Application Publication
(10) Pub. No.: US 2010/0135860 A1
(43) Pub. Date: Jun. 3, 2010

(54) HOLDER FOR HOLE-TYPE CELL CARRIER

(75) Inventors: Asaf Halamis, Karkur (IL); Michael Sister, Hulon (IL)

Correspondence Address: Daniel Feigelson, Beit Tamar, 12 Hamada Street, Rehovot, IL

(73) Assignee: CELL KINETICS LTD., Lod (IL)

(21) Appl. No.: 12/531,071

(22) PCT Filed: Mar. 12, 2008
(86) PCT No.: PCT/US2008/056617

§ 371 Date: Sep. 14, 2009

Related U.S. Application Data
(60) Provisional application No. 60/894,235, filed on Mar. 12, 2007.
(60) Provisional application No. 60/982,755, filed on Oct. 26, 2007.

(51) Int. Cl. B01L 3/00

(52) U.S. Cl. 422/104

(57) ABSTRACT

There are provided holders (10) for hole-type cell carriers (12) having structures that enable repeated contacting of cells with fluid from both above and below the cells. Other embodiments are also disclosed. The holders comprise a platform (52) for the cell carrier and a cover slip (46). Means to enable capillary flow of liquid between said platform and said cover slip are also provided.

Carriers for the analysis of a plurality of individual living cells are known in the art. For example, U.S. Pat. Nos. 4,729,949, 4,772,540, 5,272,081, 5,310,674, 5,506,141, 6,495,340, and copending, commonly-assigned PCT application PCT/IB2007/000545, the contents of all of which are incorporated herein by reference, describe cell carriers comprising grids each having a plurality of holes which are open at both faces of the cell carrier and which are shaped and sized to enable each hole to contain an individual living cell. For purposes of the present application, rigid cell carriers having holes therethrough (as opposed to rigid cell carriers having a plurality of wells which are open at only one face of the cell carrier, and as opposed to non-rigid cell carriers, such as a piece of mesh or woven fabric stretched within a frame) which are in a defined arrangement, and which thus may be assigned an address, will be referred to as “hole-type cell carriers”. It will be appreciated that the addressibility of the holes in hole-type cell carriers facilitates the repeated viewing of individual cells contained therein through a microscope or other device.

As is known in the art, typically each hole in a hole-type cell carrier has a first aperture at the upper face of the grid which constitutes the largest opening in the hole, and a second aperture at the lower face of the grid. Below the first aperture, the cross-sectional area of the hole (as measured in a plane generally parallel to the plane of the grid) may remain generally uniform through a certain depth, e.g the hole may be essentially cylindrical to a certain depth, at which point the cross-sectional area of the hole decreases, or the cross-sectional area may gradually decrease. Irrespective of whether the decrease in hole cross-sectional area is gradual or sudden, at some point below the first aperture the cross-sectional area of the hole decreases to a minimum. This minimum cross-sectional area of the hole may essentially coincide with the lower face of the grid, manifesting itself as the second aperture in the lower face of the grid, or it may occur at a point between the first aperture and second aperture. The area of the first aperture is chosen to be sufficiently large to allow a cell of a type of interest of enter the hole; the cross-section of minimum area is chosen to be sufficiently small so that the type of cell of interest cannot readily pass therethrough. The height between the first aperture and the cross-section of minimum area is chosen to ensure that no more than a single cell of the type of interest may be accommodated within the hole.

Although hole-type cell carriers are rigid, they are also relatively thin—often less than 100 microns in thickness—and thus they are susceptible to damage during handling. It is therefore in practice often found desirable to mount a hole-type cell carrier on a holder prior to use.

There are provided, in accordance with embodiments of the present invention, holders for hole-type cell carriers.

In accordance with some embodiments, there is provided a holder for a hole-type cell carrier, the holder comprising: a body; an elongate platform on said body; a first hole located within said platform into which a hole-type cell carrier can be emplaced so that the upper surface of said hole-type cell carrier is substantially level with said platform, the bottom of said first hole being open in the region where the holes of said cell carrier will be located when said cell carrier is emplaced in said first well; first and second flow-stopping structures arranged longitudinally on either side of said platform, each of said first and second flow stopping structures arranged at a height different than the level of said platform, each of said first and second flow stopping structures beginning on a proximal side of said first hole and terminating on a distal side of said first hole; a first chamber formed in said body, said first chamber being located below said first hole and in fluid communication therewith; at least one well located adjacent to said platform, said well being of greater depth than said first hole and sized to contain a greater volume of fluid than said first hole; at least one of said flow-stopping structures terminating at a location so as to provide at least one opening where a fluid flowing over said platform can flow into said well; and at least one support structure capable of supporting a cover slip over said platform and spacing said cover slip from said platform at a distance which, when a liquid is place between said platform and said cover slip, will enable capillary flow of said liquid between said platform and said cover slip.

In some embodiments, the holder further comprises a structure for changing the pressure in said first chamber. In some embodiments, the structure for changing the pressure in said first chamber comprises at least one port in said first chamber and a flexible plug in said port. In some embodiments, the structure for changing the pressure in said first chamber comprises a second chamber which is in fluid communication with said first chamber and a plunger which fits into said second chamber so as to seal the interior of said second chamber and may be moved therewithin so as to change the volume of the portion of the interior of said second chamber which is sealed.

In some embodiments, at least one of said flow-stopping structures is a ridge which rises above said platform and function as said support structure or as part of said support structure.

In some embodiments, one of said flow-stopping structures is coincident with an outer wall of said body.

In some embodiments, at least one of said flow-stopping structures is in the form of a trough arranged on a side of said platform.

In some embodiments, the first platform is shaped so that, in the region of said platform which is adjacent to said well and located between the distal end thereof and the terminal end of said flow stopping structure, said platform has at least two maximal widths and at least one minimum width which is less than either of said maximal widths, said first platform reaching said maximal widths at (a) the place where said first platform is adjacent to said distal end thereof, and (b) the place where said first platform is adjacent to the terminal end of said flow stopping structure, said first platform projecting at said maximal widths in the direction of said well. In some embodiments, on the distal side of said platform there extend laterally therefrom two spaced-apart branches, said branches extending in the direction of said well, the spacing between the branches increasing along the length of the branches, and, between the branches, a declination from said platform into said well.

In some embodiments, the well is adjacent to the distal end of said platform, the juncture between said platform and said well being characterized by a declination from the platform into the well, said flow-stopping structures terminating at the edge of said well and closely approaching each other in the vicinity of said juncture.

In some embodiments, the holder further comprises a plurality of retaining structures to prevent a cover slip which is placed over said platform from rotating or slipping out of place.

In some embodiments, the holder further comprises at the proximal end of said platform a loading structure for loading fluid onto said platform. In some embodiments, the loading structure is a depression formed in said platform and located so that, when a cover slip is placed over said platform between said retaining structures, part of said depression is covered by said cover slip and part is not. In some embodiments, the loading structure is an extension of said platform which is surrounded by walls and which, when a cover slip is placed over said platform between said retaining structures, is exposed.

In some embodiments, the holder further comprises a lower cover piece which seals said chamber from the lower surface of said body.

In some embodiments, the holder further comprises an absorbent material which is located so that, once a hole-type cell carrier is emplaced in said holder, said absorbent material will be in sufficient proximity to the underside of said cell carrier to absorb liquid which exits from the holes of said hole-type cell carrier.

In some embodiments, the holder further comprises a hole-type cell carrier emplaced therewithin. In some embodiments, the holder further comprises a hole-type cell carrier emplaced therein, said hole-type cell carrier having disposed on the underside thereof an absorbent material capable of absorbing liquid which exits from the holes of said hole-type cell carrier. In some embodiments, the cell carrier is present as part of a cell carrier unit. In some embodiments, the cell carrier is formed integrally with said cell carrier unit.

There is also provided, in accordance with some embodiments of the invention, a holder suitable for use with a hole-type cell carrier, the holder comprising: a first face, the first face having thereupon a first platform, a first hole in which a cell carrier can be mounted being formed within said first platform, troughs arranged on either side of said first platform, each of said troughs being connected to a well of greater depth than the trough to which the well is connected, a depression being formed in said first platform on one side of said first hole, and on the other side of said first hole a pair of spaced apart branches extending laterally from said platform, one of said pair of branches extending in the direction of one of said wells and the other of said pair of branches extending in the direction of the other of said wells, the spacing between each pair of branches increasing along the length of the branches, and, between each respective pair of branches, a declination from said platform into each respective well.

In some embodiments, the first hole is in fluid communication with a cavity defined in the body of said holder. In some embodiments, the roof of said cavity is shaped so that the lowest point of said roof is along the edge where said cavity meets said first hole, and the perimeter of said cavity along said roof is higher than said edge where said cavity meets said first hole.

In some embodiments, a pair of ports, each capable of receiving a plug therein, run through the walls of said cavity to the exterior walls of said holder to allow said cavity to be in fluid communication with the outside. In some embodiments, a plug is present in each port of said ports and the plugs collectively seal said cavity from said exterior walls of said holder.

In some embodiments, the floor of said cavity is shaped so that the highest point of the floor is aligned with said first hole, and the perimeter of said cavity along said floor is lower than said highest point of said floor.

In some embodiments, the floor of said cavity is formed by a covering piece which is emplaced in an aperture formed in a bottom face of said holder, whereby to seal said cavity from said bottom face.

In some embodiments, the holder further comprises a first plurality of ridges which extend to a uniform height which is above the level of said first platform. In some embodiments, said height is sufficiently low that when a cover slip is placed upon said ridges so that said cover slip covers said first platform and a portion of said depression, liquid which is placed into said depression will move in the space between said cover slip and said platform in the direction of said branches by virtue of capillary forces. In some embodiments, the holder further comprises a plurality of retaining structures which, when said cover slip is placed over said first plurality of ridges, prevent said cover slip from moving laterally or rotationally with respect to said platform.

In some embodiments, the holder further comprises a cell carrier which is located in said first hole.

There is also provided, in accordance with some embodiments of the invention, a holder suitable for use with a hole-type cell carrier, the holder comprising: an upper face, the upper face having thereupon a first platform; a first hole in which a cell carrier can be mounted being formed within said first platform; first and second ridges arranged longitudinally on either side respectively of said first platform; a third ridge arranged transversely near a distal end of said first platform; said first, second and third ridges rising to a uniform height above the level of said first platform; a depression formed near a proximal end of said first platform on a side of said first hole opposite the side where said third ridge is located; said first ridge terminating in a distal end which is closer to the distal end of said first platform than to the proximal end of said first platform but which is spaced from said third ridge; a first well which is formed in the holder in the region adjacent to the side of said first platform upon which said first ridge is located, and which extends to a depth below the level of said first platform; said first platform being shaped so that, in the region of said first platform which is located between said third ridge and said distal end of said first ridge, said first platform has at least two maximal widths and at least one minimum width which is less than either of said maximal widths, said first platform reaching said maximal widths at (a) the place where said first platform is adjacent to said third ridge, and (b) the place where said first platform is adjacent to the distal end of said first ridge, said first platform projecting at said maximal widths in the direction of said first well.

In some embodiments, the second ridge terminates in a distal end which is closer to the distal end of said first platform than to the proximal end of said first platform but which is spaced from said third ridge, said holder further comprising a second well which is formed in the holder in the region adjacent to the side of said first platform upon which said second ridge is located, and which extends to a depth below the level of said first platform; said first platform being shaped so that, in the region of said first platform which is located between said third ridge and said distal end of said second ridge, said first platform reaches said maximal widths at (a) the place where said first platform is adjacent to said third ridge, and (b) the place where said first platform is adjacent to the distal end of said second ridge, said first platform further projecting at said maximal widths in the direction of said second well.

In some embodiments, the first hole is in fluid communication with a cavity defined in the body of said holder. In some embodiments, the roof of said cavity is shaped so that the lowest point of said roof is along the edge where said cavity meets said first hole, and the perimeter of said cavity along said roof is higher than said edge where said cavity meets said first hole. In some embodiments, along said edge where said cavity meets said first hole there is located a ridge which projects out from said roof of said cavity and which surrounds said first hole.

In some embodiments, a pair of ports, each capable of receiving a plug therein, run through the walls of said cavity to the exterior walls of said holder to allow said cavity to be in fluid communication with the outside. In some embodiments, a plug is present in each port of said ports and the plugs collectively seal said cavity from said exterior walls of said holder.

In some embodiments, the floor of said cavity is shaped so that the highest point of the floor is aligned with said first hole, and the perimeter of said cavity along said floor is lower than said highest point of said floor.

In some embodiments, the floor of said cavity is formed by a covering piece which is emplaced in an aperture formed in a bottom face of said holder, whereby to seal said cavity from said bottom face.

In some embodiments, said uniform height is sufficiently low that when a cover slip is placed upon said first, second and third ridges so that said cover slip covers said first platform and a portion of said depression, liquid which is placed into said depression will move in the space between said cover slip and said platform in the direction of said third ridge by virtue of capillary forces. In some embodiments, said holder further comprises a plurality of retaining structures which, when said cover slip is placed over said first, second and third ridges, prevent said cover slip from moving laterally or rotationally with respect to said platform.

In some embodiments, the holder further comprises a cell carrier which is located in said first hole.

There is also provided, in accordance with some embodiments of the invention, a holder suitable for use with a hole-type cell carrier, the holder comprising: an upper face, the upper face having thereupon a first platform; a first hole in which a cell carrier can be mounted being formed within said first platform; first and second flow stopping structures arranged longitudinally on either side respectively of said first platform; each of said first and second flow stopping structures being of a different height than the level of said first platform; a depression formed near a proximal end of said first platform; said first flow stopping structure terminating in a distal end which is closer to the distal end of said first platform than to the proximal end of said first platform but which is spaced from said distal end; a first well which is formed in the holder in the region adjacent to the side of said first platform next to which said first flow stopping structure is located, and which extends to a depth below the level of said first platform; said first platform being shaped so that, in the region of said first platform which is located between the distal end thereof and said distal end of said first flow stopping structure, said first platform has at least two maximal widths and at least one minimum width which is less than either of said maximal widths, said first platform reaching said maximal widths at (a) the place where said first platform is adjacent to said distal end thereof, and (b) the place where said first platform is adjacent to the distal end of said first flow stopping structure, said first platform projecting at said maximal widths in the direction of said first well.

In some embodiments, one of said first and second flow stopping structures is a trough and the other of said first and second flow stopping structures is a ridge.

In some embodiments, the holder further comprises a cell carrier which is located in said first hole.

In some embodiments, the holder further comprises a cover slip.

There is also provided, in accordance with embodiments of the invention, a method for viewing at least one cell, comprising providing a holder having a hole-type cell carrier disposed therein in accordance with embodiments of the invention, loading the hole-type cell carrier in said holder with at least one cell, if necessary removing absorbent material from beneath the hole-type cell carrier and viewing said at least one cell. In some embodiments, prior to said viewing, said at least one cell is contacted with a liquid by placing a cover slip on said ridges and placing a quantity of said liquid in said depression, whereby to facilitate movement of said liquid in the direction of said at least one cell by virtue of capillary forces and contacting of said at least one cell with said liquid. In some embodiments, prior to said viewing said at least one cell is repeatedly contacted with a liquid by placing a cover slip on said ridges and placing a quantity of said liquid in said depression, whereby to facilitate movement of said liquid in the direction of said at least one cell by virtue of capillary forces and contacting of said at least one cell with said liquid. In some embodiments, at least two liquids are each contacted at least once with said at least one cell. In some embodiments, one liquid is contacted at least twice with said at least one cell.

In another aspect, there is provided, in accordance with some embodiments of the invention, a method for loading a cell carrier for retaining a plurality of individual living cells of a predetermined type in an array of predefined discrete locations,
the cell carrier comprising a body that defines a first outer surface and a second surface, the body having an ordered array of holes therethrough at predefined discrete locations, each of the holes communicating between the first outer surface and the second surface, wherein each of the holes has: (i) a first cross section at the first outer surface of such dimensions that at least a portion of each of an individual living cell of said predetermined type can pass through the first cross section without suffering substantial damage; (ii) a second cross section at a level intermediate between the first outer surface and the second surface of such dimensions that an individual living cell of the predetermined type cannot pass through the second cross section; (iii) a height between the first outer surface and the level of the second cross section such that at least a portion of an individual living cell of said predetermined type is containable within the hole; wherein at least a portion of each hole between the level of the second cross section and the second surface is of maximum cross-sectional dimension which is sufficiently small to cause motion of a liquid therethrough toward the second surface by capillary action,
the second surface being in proximity to or constituting part of a capillary-action inducing structure,
the method comprising placing an amount of a cell-containing liquid on the first outer surface.

There is also provided, in accordance with some embodiments of the invention, a method for loading a cell carrier for containing and retaining a plurality of individual living cells of a predetermined type in an array of predefined discrete locations,
the cell carrier comprising a body that defines a first outer surface and a second surface, the body having an ordered array of holes therethrough at predefined discrete locations, each of the holes communicating between the first outer surface and the second surface, wherein each of the holes has: (i) a first cross section at the first outer surface of such dimensions that at least a portion of each of an individual living cell of said predetermined type can pass through the first cross section without suffering substantial damage; (ii) a second cross section at a level intermediate between the first outer surface and the second surface of such dimensions that an individual living cell of the predetermined type cannot pass through the second cross section; (iii) a height between the first outer surface and the level of the second cross section such that at least a portion of an individual living cell of said predetermined type is containable within the hole; wherein at least a portion of each hole between the level of the second cross section and the second surface is of a maximum cross-sectional dimension which is sufficiently small to cause motion of a liquid therethrough toward the second surface by capillary action,
the method comprising bringing the second surface into proximity with, or causing at least a portion of the second surface to constitute a part of, a capillary-action inducing structure, and thereafter placing an amount of a cell-containing liquid on the first outer surface.

In accordance with some embodiments, the portion of each hole between the level of the second cross section and the second surface begins at or below the level of the second cross section and continues to the second surface. In accordance with some embodiment, the portion has a cross-sectional dimension of at least 1 micron. In accordance with some embodiments, the portion has a cross-sectional dimension of at least 2 microns. In accordance with some embodiments, the portion has a cross-sectional dimension of at least 3 microns. In accordance with some embodiments, the portion has a cross-sectional dimension of at least 4 microns. In accordance with some embodiments, the portion has a cross-sectional dimension of at least 5 microns. In accordance with some embodiments, the portion has a cross-sectional dimension of at least 6 microns. In accordance with some embodiments, the portion has a cross-sectional dimension of at least 7 microns. In accordance with some embodiments, the portion has a cross-sectional dimension of at least 8 microns. In accordance with some embodiments, the portion has a cross-sectional dimension of at least 9 microns. In accordance with some embodiments, the portion has a cross-sectional dimension of at least 10 microns. In accordance with some embodiments, the portion has a cross-sectional dimension of at least 11 microns. In accordance with some embodiments, the portion has a cross-sectional dimension of at least 12 microns. In some embodiments, the cross-sectional dimension is a diameter.

In some embodiments, the maximum cross-sectional dimension of the at least a portion of each hole between the level of the second cross section and the second surface is 6 microns or less. In some embodiments, the maximum cross-sectional dimension of the at least a portion is 5 microns or less. In some embodiments, the maximum cross-sectional dimension of the at least a portion is 4 microns or less. The cross-sectional dimension is a diameter.

In some embodiments, the capillary-action inducing structure is an absorbent material which is in sufficient proximity to the second surface to absorb liquid which exits from the holes. In some embodiments, the absorbent material contacts the second surface. In some embodiments, the absorbent material is permanently affixed to the second surface. In some embodiments, the absorbent material is removably affixed to the second surface.

In some embodiments, the capillary-action inducing structure is a structure which, together with at least a portion of the second surface, forms a passage which passes through the body transverse to at least a portion of the array of holes and which is open at at least one end to a third outer surface of the body, said passage being of sufficient thinness to cause motion of a liquid therethrough toward the third surface by capillary action.

In some embodiments, the portion of each hole between the level of the second cross section and the second surface begins at or below the level of the second cross section and continues to the second surface.

In some embodiments, the cell carrier is made from a material selected from the group consisting of metals, plastics, ceramics, silicon-based materials and glass.

There is also provided, in accordance with embodiments of the invention, a cell carrier for retaining individual living cells of a predetermined type in an array of predefined discrete locations, the cell carrier comprising a body that defines a first outer surface and a second surface, the body having an ordered array of holes therethrough at predefined discrete locations, each of the holes communicating between the first outer surface and the second surface, wherein each of the holes has: (i) a first cross section at the first outer surface of such dimensions that at least a portion of an individual living cell of said predetermined type can pass through the first cross section without suffering substantial damage; (ii) a second cross section at a level intermediate between the first outer surface and the second surface of such dimensions that an individual living cell of said predetermined type cannot pass through the second cross section; (iii) a height between the first outer surface and the level of the second cross section such that at least a portion of said individual living cell is containable within the hole; wherein at least a portion of each hole between the level of the second cross section and the second surface is of a maximum cross-sectional dimension sufficiently small to cause motion of a liquid therethrough toward said the surface by capillary action.

In some embodiments, the second surface is in proximity to or constitutes part of a capillary-action inducing structure.

In accordance with some embodiments, the portion of each hole between the level of the second cross section and the second surface begins at or below the level of the second cross section and continues to the second surface. In accordance with some embodiment, the portion has a cross-sectional dimension of at least 1 micron. In accordance with some embodiments, the portion has a cross-sectional dimension of at least 2 microns. In accordance with some embodiments, the portion has a cross-sectional dimension of at least 3 microns. In accordance with some embodiments, the portion has a cross-sectional dimension of at least 4 microns. In accordance with some embodiments, the portion has a cross-sectional dimension of at least 5 microns. In accordance with some embodiments, the portion has a cross-sectional dimension of at least 4 microns. In accordance with some embodiments, the portion has a cross-sectional dimension of at least 6 microns. In accordance with some embodiments, the portion has a cross-sectional dimension of at least 7 microns. In accordance with some embodiments, the portion has a cross-sectional dimension of at least 8 microns. In accordance with some embodiments, the portion has a cross-sectional dimension of at least 9 microns. In accordance with some embodiments, the portion has a diameter of at least 10 microns. In accordance with some embodiments, the portion has a cross-sectional dimension of at least 11 microns. In accordance with some embodiments, the portion has a cross-sectional dimension of at least 12 microns. In accordance with some embodiments, the cross-sectional dimension is a diameter.

In some embodiments, the maximum cross-sectional dimension of the at least a portion of each hole between the level of the second cross section and the second surface is 6 microns or less. In some embodiments, the maximum cross-sectional dimension of the at least a portion is 5 microns or less. In some embodiments, the maximum cross-sectional dimension of the at least a portion is 4 microns or less. In accordance with some embodiments, the cross-sectional dimension is a diameter.

In accordance with some embodiments, the second surface is a second outer surface which is in contact with an absorbent material which absorbs liquid which exits from said holes. In some embodiments, the absorbent material is permanently affixed to the second surface. In some embodiments, the absorbent material is removably affixed to the second surface.

In accordance with some embodiments, the second surface constitutes at least a portion of a passage which passes through the body transverse to at least a portion of the array of holes and which is open at at least one end to a third outer surface of the body, the passage being of sufficient thinness to cause motion of a liquid therethrough toward the third surface by capillary action.

In accordance with some embodiments, the cell carrier has cells disposed within at least a portion of the holes.

In accordance with some embodiments, the cell carrier is formed from a plastic. In accordance with some embodiments, the plastic is polycarbonate, polystyrene, styrene, acrylonitrile, polyacetal or another plastic. In accordance with other embodiments, the cell carrier is formed from glass. In accordance with some embodiments, the cell carrier according is formed from metal, ceramic or a silicon-based material.

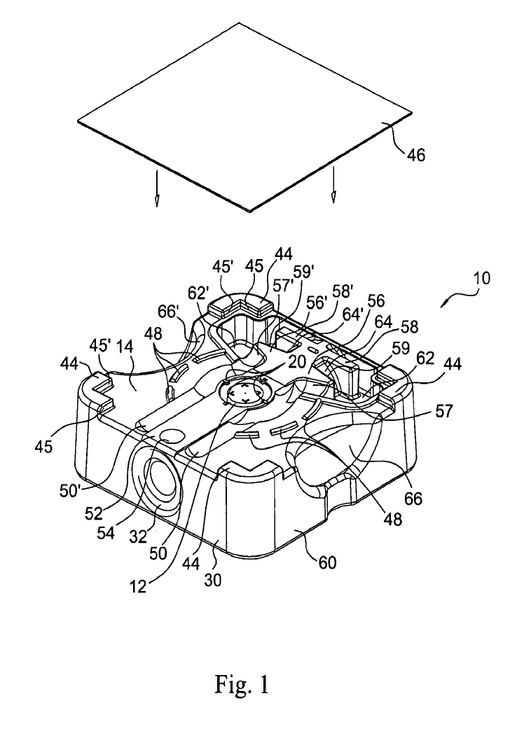

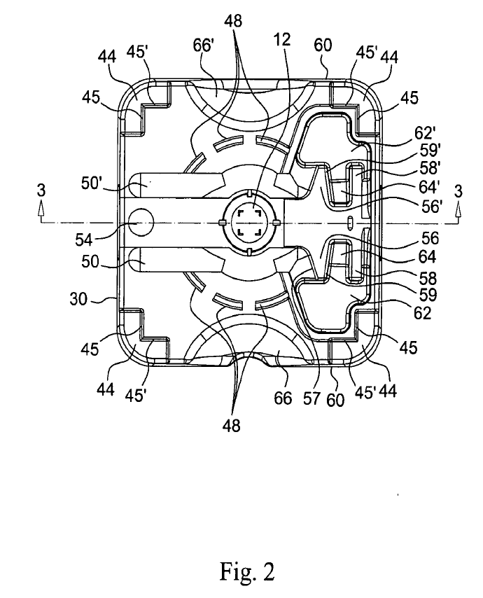

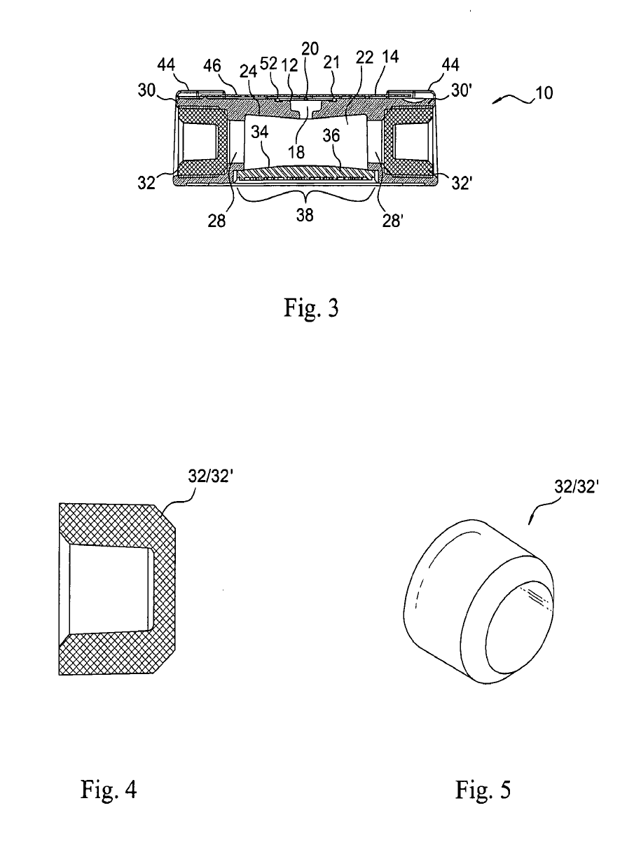

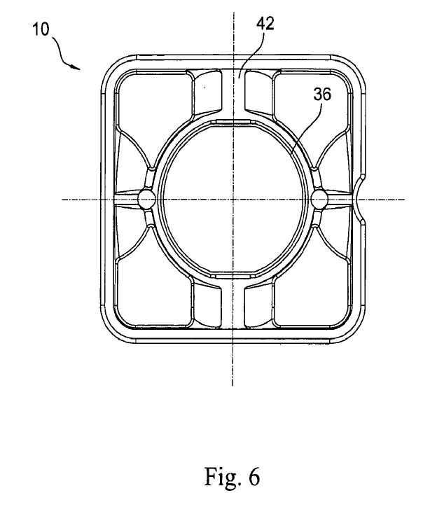

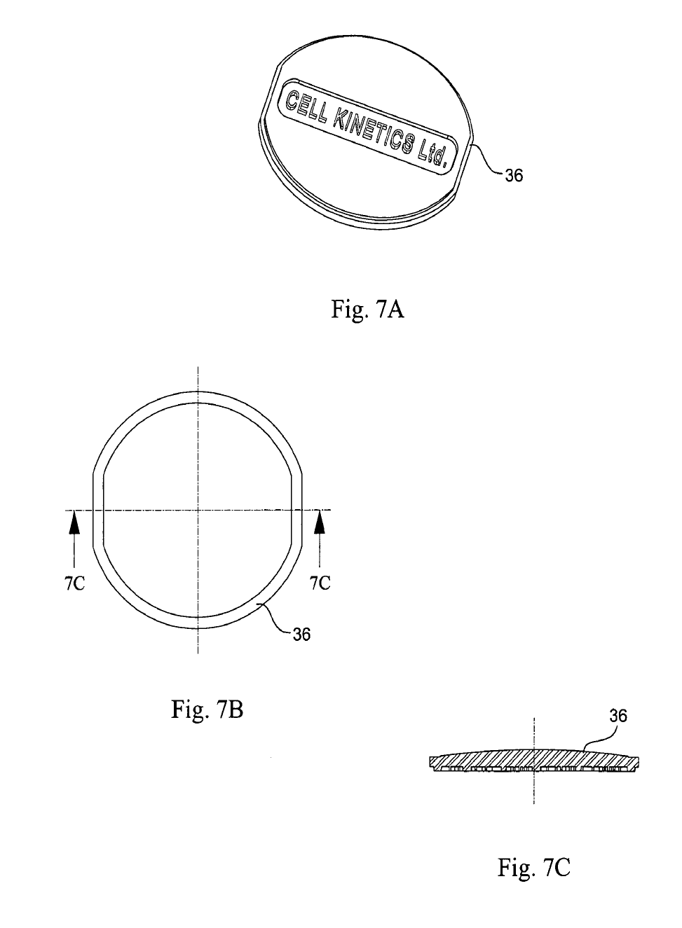

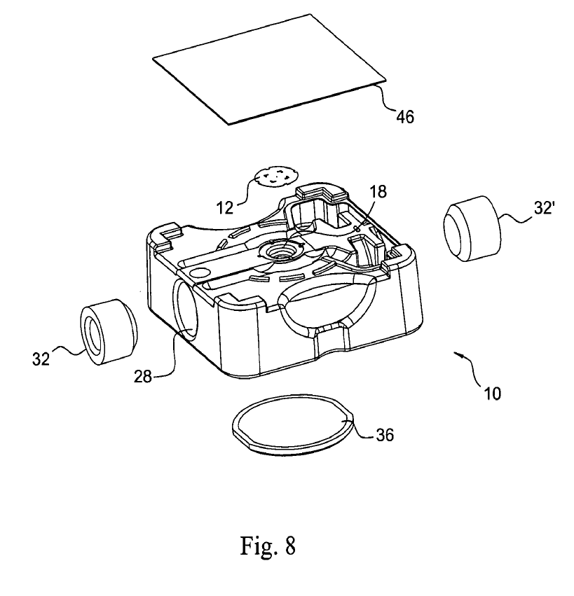

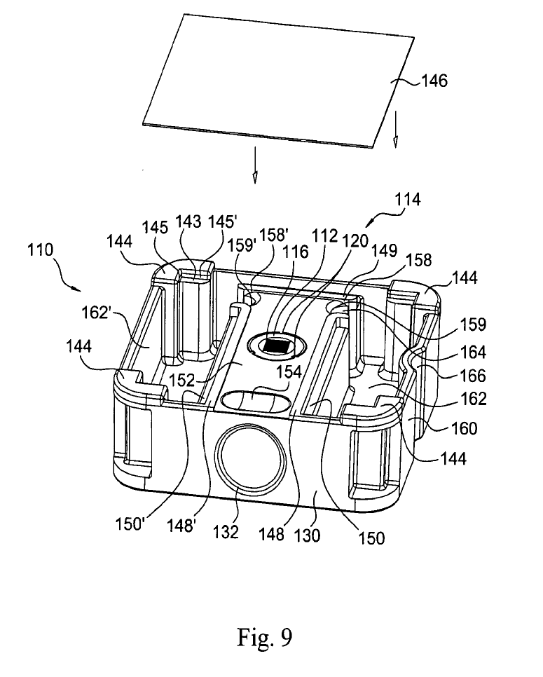

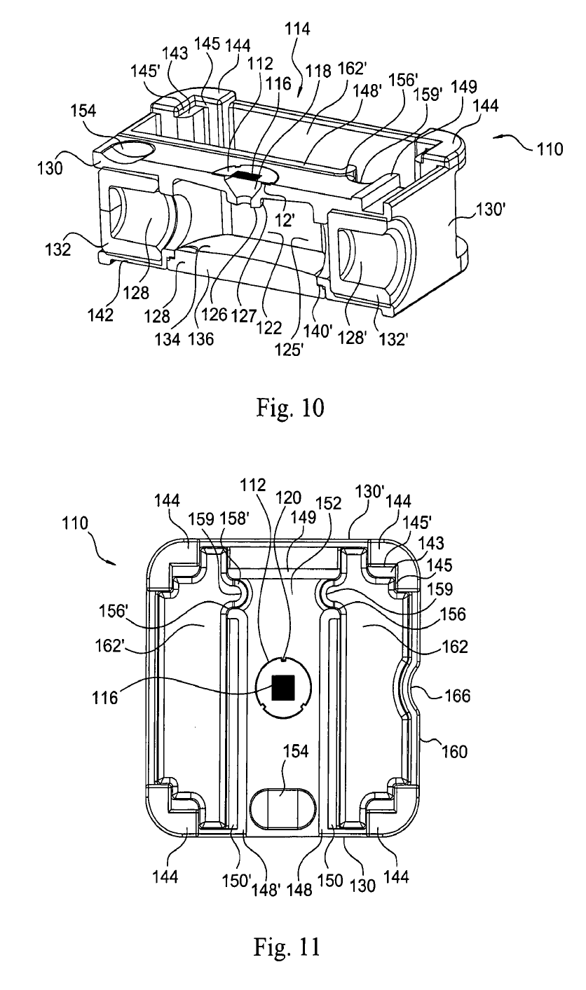

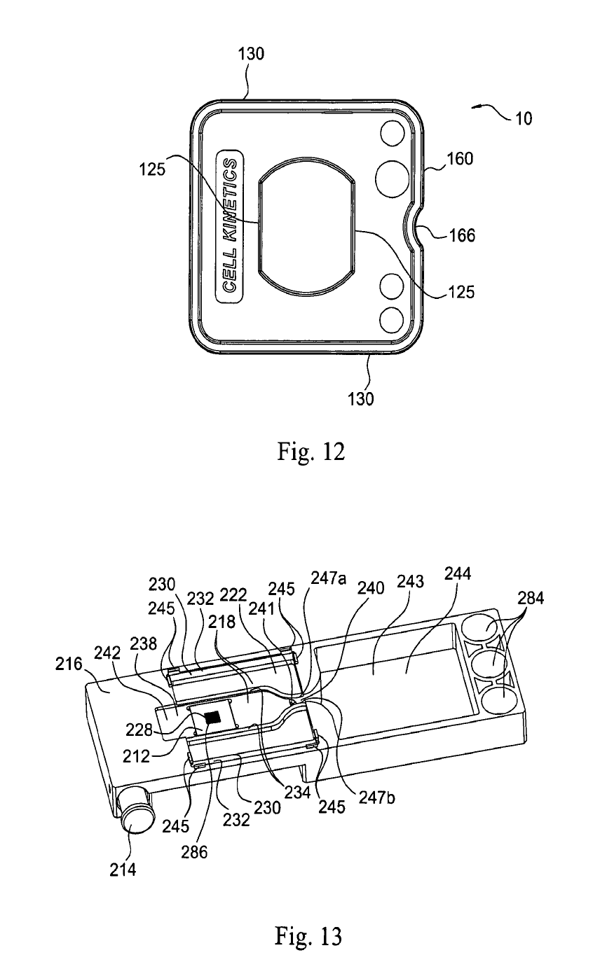

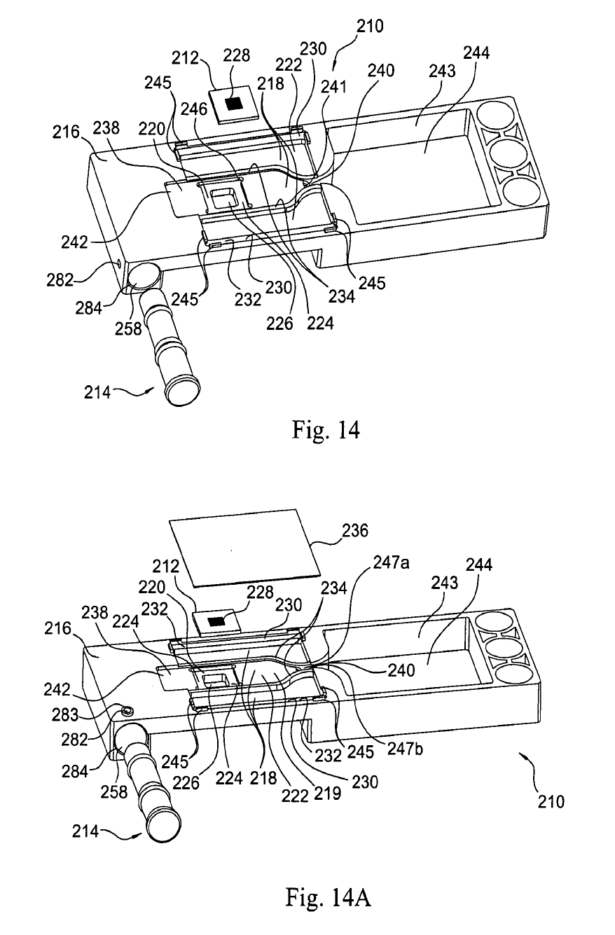

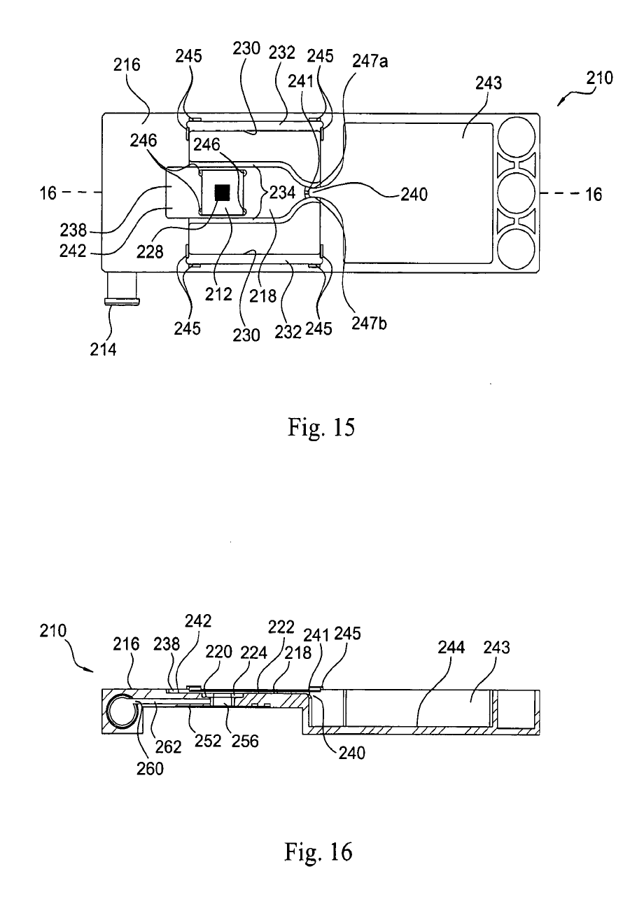

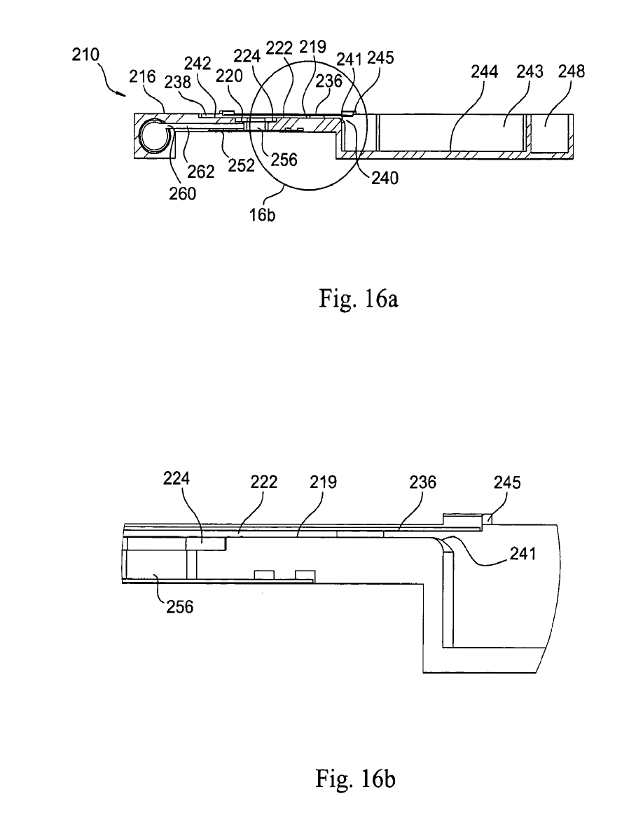

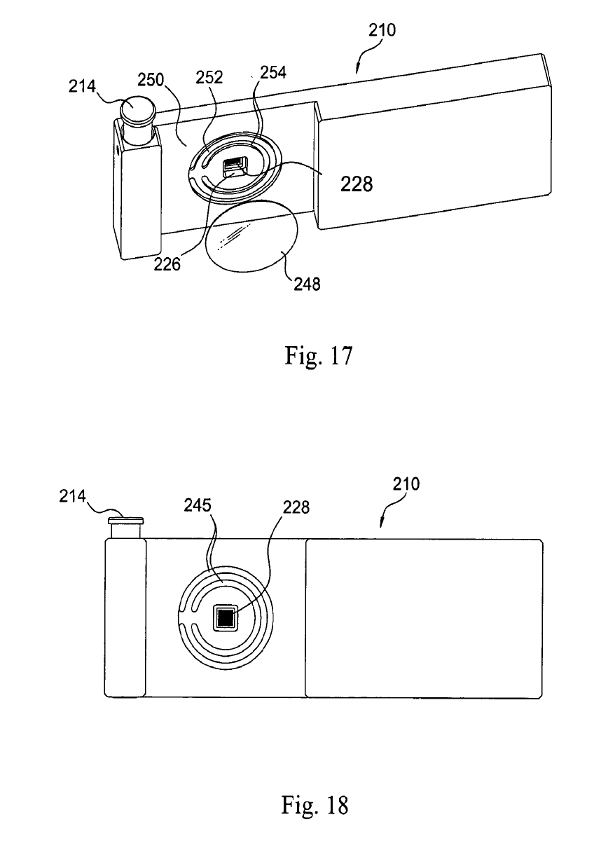

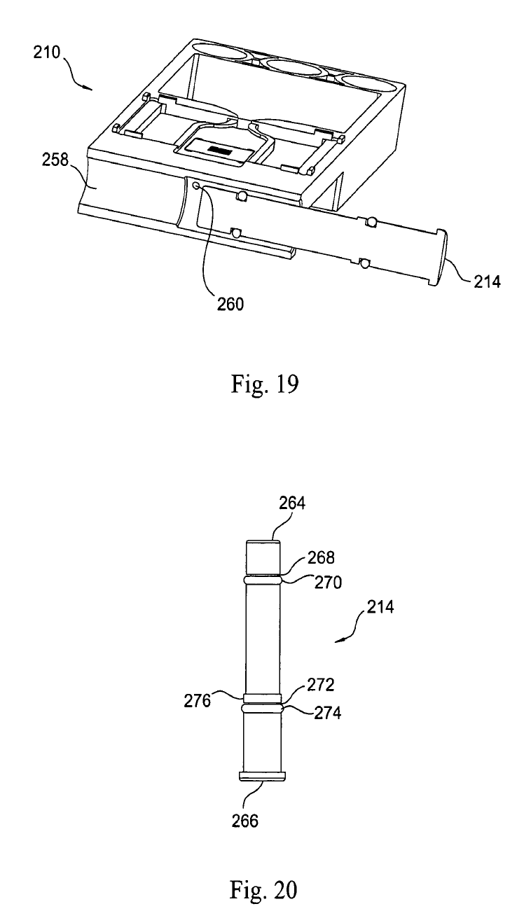

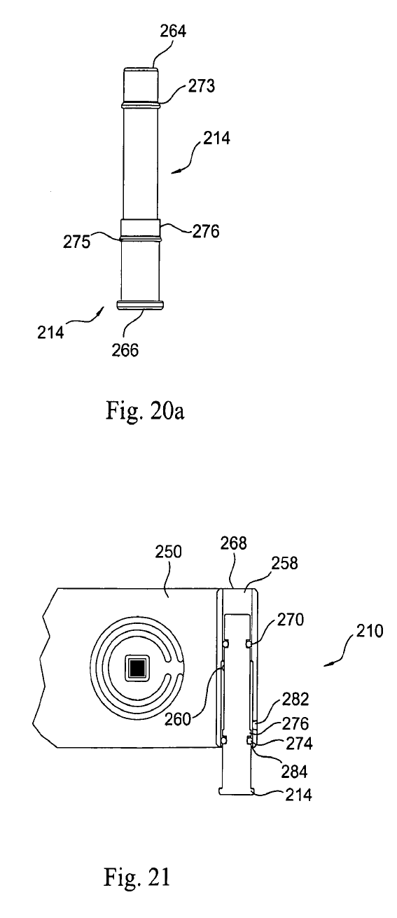

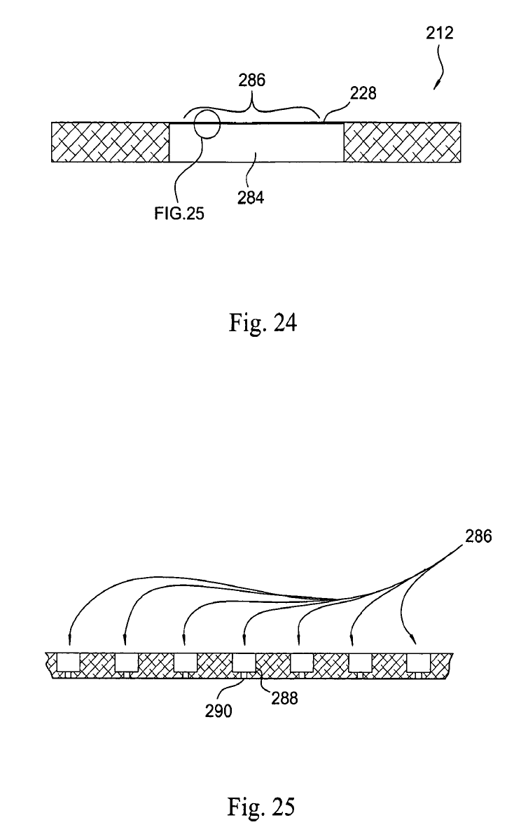

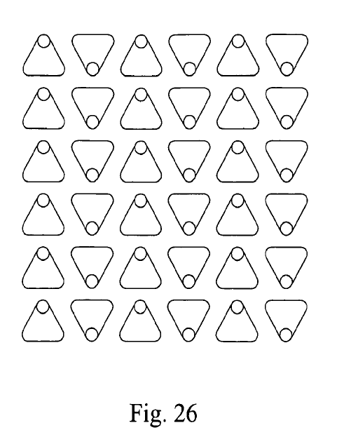

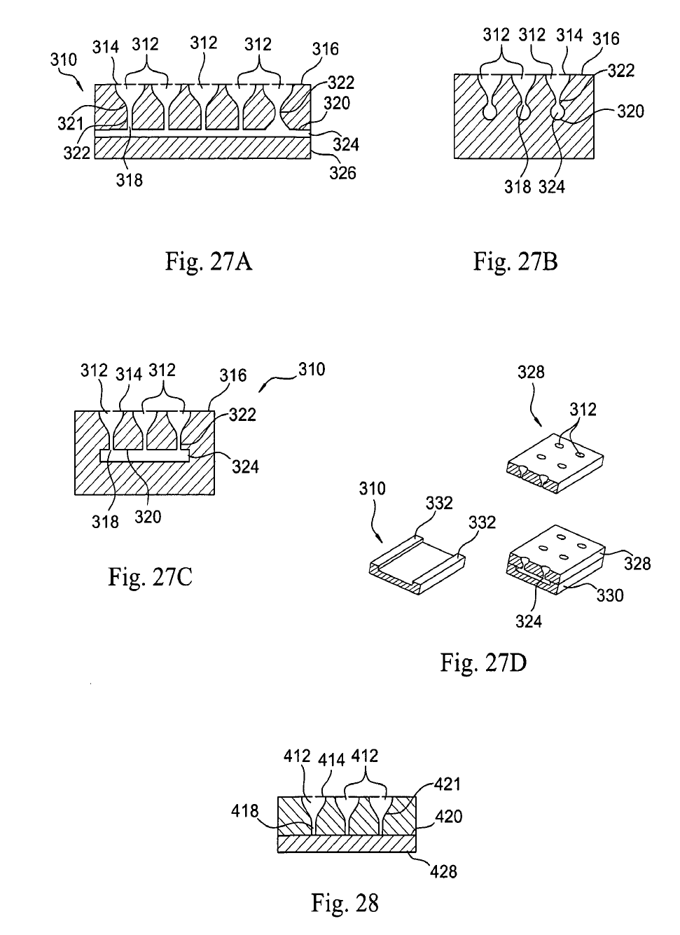

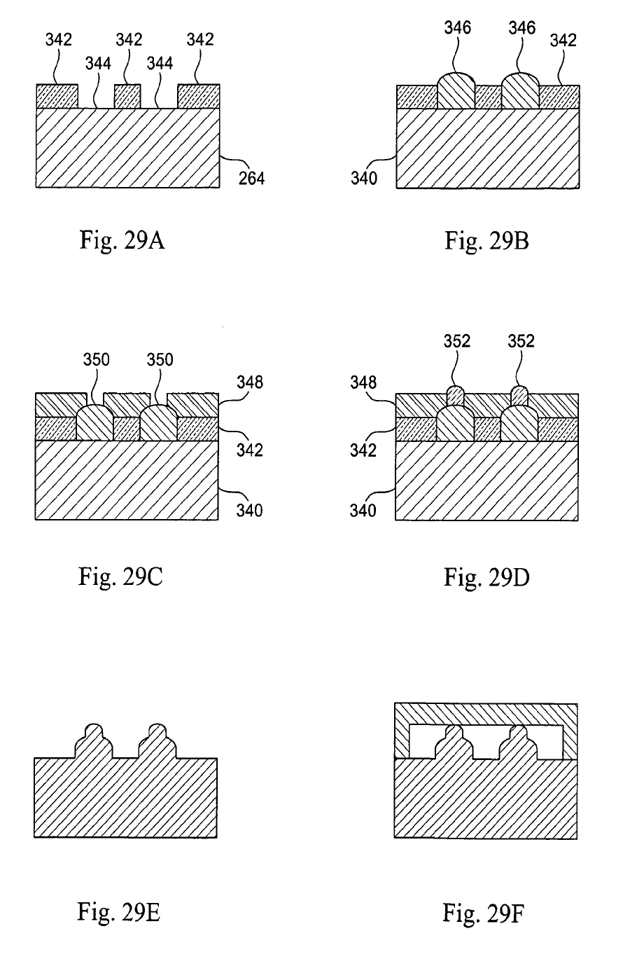

The attached FIGS. 1-26 depict various views of a device, or portions thereof, constructed and operative in accordance with embodiments of the invention. However, it will be appreciated that the drawings are illustrative and not intended to limit the scope of the invention. FIG. 1 is an isometric view of a holder, constructed and operative in accordance with embodiments of the invention. FIG. 2 is a plan view from the top side of the holder shown in FIG. 1. FIG. 3 is a cross-sectional view of the holder of FIG. 2, taken along line 3-3 in FIG. 2. FIGS. 4 and 5 cross-sectional and isometric views, respectively, of a plug which can be inserted into the holder of FIGS. 1 and 2, as shown in FIG. 2. FIG. 6 is a plan view from the bottom side of the holder shown in FIG. 1. FIG. 7A is an isometric view of a covering; FIG. 7B is a plan view from of this covering; and FIG. 7C is a cross-sectional view of this covering, taken along line 7C-7C of FIG. 7B. FIG. 8 is an exploded view of FIG. 1, in which not only the cover slip but the plugs, cell carrier and bottom covering are shown in exploded view. FIG. 9 is an isometric view of a holder, constructed and operative in accordance with embodiments of the invention. FIG. 10 is a plan view from the top side of the holder shown in FIG. 9. FIG. 11 is a plan view from the bottom side of the holder shown in FIG. 9. FIG. 12 is a cross-sectional view taken along line 12-12 of FIG. 9. FIG. 13 is an isometric view of a holder, constructed and operative in accordance with embodiments of the invention. FIGS. 14 and 14A are similar to FIG. 13, but in exploded view. FIG. 15 is a plan view from the top side of the holder of FIG. 13. FIGS. 16 and 16A are cross-sectional views of the holder shown in FIG. 15, taken along line 16-16 of FIG. 15. FIG. 16B is an enlarged view of a portion of FIG. 16A. FIG. 17 is an isometric view from the bottom of a portion of the holder of FIG. 13, in partly exploded view. FIG. 18 is a plan view from the bottom side of the holder of FIG. 13. FIG. 19 is partial isometric view of the holder of FIG. 13, in which a portion has been cut-away to reveal the interior of transverse passageway 258. FIGS. 20 and 20A show versions of a plunger, constructed and operative in accordance with embodiments of the invention. FIGS. 21, 22 and 23 show part of the holder of FIG. 13 from the bottom, in which transverse passageway and plunger 214 are show in cut-away view. FIG. 24 shows a cross-sectional view of a cell carrier unit with a hole-type cell carrier integrally formed therewith, constructed and operative in accordance with embodiments of the invention. FIG. 25 shows an enlarged view of some of the holes of the combined cell carrier/cell carrier unit of FIG. 24. FIG. 26 shows in plan view from the top a portion of a cell carrier, constructed and operative in accordance with embodiments of the invention. FIGS. 27A, 27B, 27C, 27D and 28 show hole-type cell carriers, constructed and operative in accordance with embodiments of the invention. FIGS. 29A-29F depict means of manufacturing hole-type cell carriers such as those shown in FIGS. 27-28.

FIGS. 1 to 8 depict a holder 10 for a hole-type cell carrier 12. Holder 10 may be made for example from plastic, e.g. polystyrene, polycarbonate, polymers of acrylic acid and acrylic acid derivatives (e.g. polyacrylates and poly(meth)acrylates), and polydimethylsiloxane, as well as co- and terpolymers made from at least one of the monomers used to make these polymers, such as acrylonitrile styrene acrylate (ASA), for example by injection molding. In the context of the present application, the terms “a polyacrylate” and “a poly(meth)acrylate” encompass respectively not only polyacrylate and poly(meth)acrylate, but also derivatives thereof, such as poly(methyl methacrylate), polyacrylonitrile and the like.

As shown in the figures, a hole-type cell carrier 12 may be mounted in the center of a raised platform 52 formed in the upper face 14 of holder 10, although it will be appreciated that holders without cell carriers mounted thereon are provided in accordance with some embodiments of the invention. It will also be appreciated that while the holes 16 in cell carrier 12 are in a square array, in the present drawings, for the sake of simplification only some of the holes of cell carrier 12 near the corners of the array are shown, and in general the holes in a cell carrier need not be in a square array. Furthermore, although the holes 16 in cell carrier 12 are depicted only schematically and are not drawn to scale, the depiction of holder 10 is drawn to scale. Thus, holder 10 is approximately 3 cm long×3 cm wide×1 cm deep. As shown in the figures, cell carrier 12 is of a generally circular shape, having a square array of holes in the center thereof, and therefore holder 10 has a circular hole 18 into which cell carrier 12 may be inserted. In order to properly align cell carrier 12 relative to holder 10, and in some embodiments to hold cell carrier 12 in place and at the same time prevent unwanted rotation of cell carrier 12 relative to holder 10, cell carrier 12 is formed with four small indentations spaced about the circumference thereof, and a plurality of tabs 20 are formed in holder 10 to fit into the indentations in cell carrier 12 and thus hold cell carrier 12 in a stable rotational position relative to holder 10. However, it will be appreciated that the upper aperture of hole 18 may be formed so as to accommodate a cell carrier of a different shape, and that other mechanisms besides the indentation/tab mechanism may be used to maintain the holder and carrier in a fixed configuration relative to one another. It will be appreciated that in those embodiments in which tabs 20 are used to hold cell carrier 12 in place, the tabs will extend slightly over the upper surface of cell carrier 12, without occluding any of the holes of cell carrier 12.

Hole 18 consists of three coaxially arranged cylindrical portions. A lip 21, upon which carrier 12 rests, defines the uppermost portion of hole 18. Lip 21 is spaced from platform 52 just enough to allow the upper surface of cell carrier 12 to reside at substantially the same height as the surface of platform 52. The lip is designed so that only an outer part of cell carrier 12 will rest thereupon, and thus lip 21 will not occlude the holes in cell carrier 12 or obstruct viewing of cells contained in cell carrier 12. It will be appreciated that in some embodiments, carrier 12 may be affixed to lip 21, for example by use of an adhesive or by ultrasonic welding, in which case in some embodiments tabs 20 may be foregone. The middle portion of hole 18 is of narrower diameter than the uppermost portion of hole 18. The lowest portion of hole 18 is of still narrower diameter, and is in fluid communication with cavity 22, which is located in the interior of holder 10. The roof 24 of cavity 22 is defined by the body of holder 10, and tapers up from the edge 26 where hole 18 meets cavity 22. The taper directs bubbles of air or other gas which may become trapped in cavity 22 to ascend away from the center of the cavity, and thus not interfere with illumination or irradiation of carrier 12.

As seen in plan view, cavity 22 is of generally circular cross-section, although on two opposite sides thereof, the walls of cavity 22 have flattened portions which open to ports 28 and 28′. Ports 28 and 28′ open to faces 30 and 30′ respectively of holder 10 and thus, when plugs 32 and 32′ (which will be described in more detail below) are not present in ports 28 and 28′, ports 28 and 28′ are in fluid communication with the exterior.

The floor 34 of cavity 22 is defined by the top surface of a covering 36. Covering 36 may be manufactured separately from the rest of holder 10 and emplaced within an aperture 38 formed by rim 40 in the bottom of holder 10, whereby to seal off cavity 22 from the underside 42 of holder 10. Covering 36 may be held in place by pressure, for example if the diameter of cover 36 is slightly larger than that of aperture 38, in which case covering 36 may if desired be removed from holder 10 after use, or covering 36 may be held in place, e.g. using an adhesive or by ultrasonic welding. Covering 36 may be made of any suitable material, and thus may but need not be made of the same material as the rest of holder 10, and thus may for example be made by injection molding. The area of covering 36 which, when covering 36 is emplaced, is aligned beneath the holes of cell carrier 12, is transparent to the frequency of electromagnetic radiation used to illuminate the cells in cell carrier 12. Alternatively, covering 36 may be formed integrally with the rest of holder 10. Optionally, words may be formed in covering 36.

The top of covering 36, i.e. floor 34 of cavity 22, tapers down from its center. Thus, taking into account the shape of the top of cavity 22, as seen in FIG. 3, in cross-sectional view cavity 22 is of concave shape. This means that holder 10 may be flipped-over, so that face 14 faces the floor of a laboratory rather than the ceiling, and used for viewing cells, for example in an inverted microscope, and in either the face 14-up position or the face 14-down position, and air bubbles which may be present within cavity 22 will ascend away from the center of the cavity.

As shown in the figures, in use plugs 32 and 32′ are placed in ports 28 and 28′, respectively, and in some embodiments of the invention a holder comprises plugs as well, although it will be appreciated that plugs per se are not part of the invention. Plugs 32 and 32′ are of a generally open cylindrical shape, with a beveled edge on the exterior of the closed side, so that when fitted into ports 28 and 28′, the closed ends of plugs 32 and 32′ are close to cavity 22 and seal cavity 22 from faces 30 and 30′ respectively. Plugs 32 and 32′ are made from a flexible material, e.g. rubber, silicone or a thermoplastic elastomer. In order to fill cavity 22 with liquid, e.g. a nutrient solution for cells on cell carrier 12, a liquid may be injected through one of the plugs into cavity 22. Because cavity 22, via hole 18, is in fluid communication with the exterior, as cavity 122 fills with liquid, air in the cavity will exit via hole 18; in those cases in which a cell carrier is emplaced in hole 18 and affixed to lip 21, the air will exit via the holes of the cell carrier. If it is desired to change the liquid in cavity 22, old liquid may be withdrawn through one plug and simultaneously or thereafter new liquid may be injected through the other plug. Injection of liquid through the plugs may be accomplished e.g. by inserting a needle through the relevant plug. Alternatively, in some embodiments, plugs 32 and 32′ have a small slit in the middle thereof, so that a syringe may be used to inject liquid, without resort to a needle, for example by placing the syringe over the slit. In such cases, the plugs are constructed such that application of pressure to the syringe will force the liquid in the syringe through the slit. Upon cessation of the pressure and cessation of fluid flow from the syringe, the slit self-seals. Plugs 32 and 32′ may be held in place by pressure between the walls of plugs 32/32′ and the walls of ports 28/28′, respectively, or plugs 32/32′ may held in place e.g. using an adhesive or by mechanical means.

Although a cell carrier 12 may be loaded with living cells prior to emplacement in hole 18, in general the cell carrier will first be emplaced in the holder, and then loaded with living cells. Such loading may be accomplished, for example, by placing plugs in ports 28 and 28′; injecting sufficient solution into cavity 22 to at least fill the bottom of hole 18, preferably to completely fill hole 18 up to cell carrier 12; applying pressure on the plugs, whereby to decrease the volume of cavity 22—in accordance with some embodiments sufficiently decreasing the volume to bring the solution into contact with the lower surface of cell carrier 12 if it is not already in contact therewith, in accordance with some embodiments sufficiently decreasing the volume to completely cover the upper surface of cell carrier 12 with the solution; placing a drop of cell-containing solution on the top surface of cell carrier 12; and releasing the pressure on the plugs whereby to increase the volume in cavity 22 to its previous state and thus create a pressure differential and draw the cell-containing solution through the cell carrier, whereby to load the cell carrier with cells.

As will be appreciated by persons familiar with hole-type cell carriers and their use, it is often desired to contact the cells on the cell carrier with a liquid, for example to expose the cells to a solution containing a stimulus, to stain the cells, or to wash the cells after staining the cells or exposing the cells to a solution containing a stimulus. Cell carriers held in a holder 10 may be washed or otherwise contacted with a liquid by methods known the art. However, as will now be explained, holder 10 facilitates very gentle washing of cells, or other contacting of cells with a liquid, using a minimum of washing solution and without having to move the cell carrier and/or the holder from e.g. a microscope platform, by taking advantage of capillary action. At the corners of upper face 14 of holder 10 there are a plurality of raised corner pieces 44, each of which contains a pair of faces 45 and 45′ which are mutually perpendicular, thus defining a 90-degree angle, and which are also perpendicular to face 14, so that the corner pieces collectively define the corners of a square. A cover slip 46, which is made of any suitable material which is transparent to the electromagnetic radiation used to illuminate the cells, such as glass or plastic, may thus be placed within this square, and the presence of corner pieces 44 will prevent lateral or rotational movement of cover slip 46 relative to face 14 of holder 10. It will be appreciated that although the figures show a holder in which corner pieces 44 have been fabricated to hold a cover slip of a particular size, holders in accordance with embodiments of the invention can readily be made to hold cover slips which differ in size from cover slip 46. Moreover, it will be appreciated that instead of corner pieces 44, a plurality of ridges (not shown) may be formed on surface 14 along the perimeter of holder 10 or in close proximity to the perimeter, which will prevent lateral or rotational movement of cover slip 46 relative to face 14. A plurality of ridges 48 of equal height, generally in the range of from 0.01 mm to 0 5 mm height, rise above face 14 and support cover slip 46 near the center of holder 10 and space cover slip 46 from face 14 and the surface of platform 52. It will be appreciated that although in some embodiments of the invention, a holder is provided with a cover slip, the cover slip is not necessary in all embodiments of the invention, and cover slips per se are not part of the invention.

A pair of troughs 50 and 50′ are formed in the upper side of holder 10, running generally perpendicular to faces 30 and 30′, although in the vicinity of hole 18 platform 52 follows the contour of the uppermost portion of hole 18, widening and then narrowing again to its original width, and troughs 50/50′ likewise follow the contour of the widened section of platform 52. Troughs 50 and 50′ are separated by platform 52 of upper face 14; platform 52 is slightly raised relative to the rest of upper face 14. Near face 30, a bowl-shaped indentation 54 is formed in platform 52. Indentation 54, which is sized to hold a small quantity of liquid, is positioned so that when cover slip 46 is put in place, part of indentation 54 will be covered by cover slip 46 and part will not be. In some embodiments, at least half of indentation 54 will be covered by cover slip 46. Thus, when cover slip 46 is placed on ridges 48 and indentation 54 is then filled with a liquid, usually a washing or staining solution, the liquid will be drawn by capillary action from indentation 54 along platform 52 in the direction of cell carrier 12. Troughs 50/50′ are of sufficient depth that the capillary forces in the regions between the troughs and the cover slip will be weak, thus ensuring that liquid will remain in the space between platform 52 and cover slip 46, and not move into the troughs or beyond the troughs. In this manner, when a cell carrier 12 is emplaced in holder 10, the liquid will pass over the surface of cell carrier 12 and contact the cells in the cell carrier, for example to wash the cells.

Once liquid has passed over cell carrier 12, it will continue in its path along platform 52. However, near face 30′, on both sides of platform 52, platform 52 widens into branches 56, 56′, 58 and 58′, which extend toward faces 60 and 60′, respectively. Branches 56/56′ are wider at their bases where they extend from platform 52 than at their tips. Branches 58/58′, which extend toward faces 60/60′ to the same extent as branches 56/56′, respectively, are of essentially the same width throughout. Between branches 56/58 and branches 56′/58′, platform 52 narrows. Adjacent to where branches 56/56′ begin to extend toward faces 60/60′, respectively, troughs 50 and 50′ change course and gradually become deeper, leading at the ends of branches 56/56′ into wells 62 and 62′, respectively, which are formed in holder 10. The depth of troughs 50/50′ along the edges 57/57′ of branches 56/56′ is maintained so that liquid flowing in the space between platform 52 and cover slip 46 will flow along branches 56/56′, further along platform 52, and along branches 58/58′, but will not move into the troughs or beyond the troughs.

Branches 56 and 58, and branches 56′ and 58′, respectively, are sufficiently close to each other that liquid will flow in between adjacent branches. However, whereas the edges of branches 58/58′ are generally parallel to face 30′, the edges 59/59′ of branches 56/56′ closest to branches 58/58′, respectively, angle away from branches 58/58′. In between branches 56/58 and 56′/58′, the surface sharply drops from platform 52 along declinations 64/64′ into wells 62/62′ respectively, which run to a depth of approximately 3-6 mm below platform 52. Consequently, liquid flowing in between branches 56/58 and 56′/58′ moves along cover slip 46 above declinations 64/64′ until a sufficient amount of liquid has collected, and the distance between cover slip 46 and declinations 64/64′ is sufficient, that the liquid in between branches 56/58 and 56′/58′, respectively, flows down declinations 64/64′ into wells 62/62′. This ensures a continuous flow of liquid from indentation 54 into wells 62/62′, until the liquid in indentation 54 is substantially depleted, thus enabling washing of cells in cell carrier 12. As depicted in the figures, each of wells 62/62′ can hold approximately 200 microliters of liquid, which enables several washings of the cell carrier of e.g. 10 to 30 microliters per wash, although it will be appreciated that holder 10 may be formed in accordance with embodiments of the invention which hold different amounts of liquid, e.g. larger amounts to enable more washings.

As shown in the figures, the holder 10 contains a pair of indentations 66/66′ formed approximately mid-way along the edges where face 14 and faces 60/60′ meet, respectively. Indentations 66/66′ can accommodate fingertips and thus facilitate manual emplacement and removal of cover slip 46.

Although washing of a cell carrier as described above may be carried out only when the holder is in the upright position, viz. when surface 14 faces upward, as stated above, the bottom of cavity 22 is formed so that if the holder is inverted, for example for use with an inverted microscope, air within the cavity will stay near the circumference of the cavity, away from the center area where the cells are illuminated and through which they are viewed. It will be appreciated that when the holder is turned upside-down, adhesive and cohesive forces due to liquid in the space between cover slip 46 and platform 52 will hold the cover slip in place, provided that a sufficiently small amount of liquid is present in wells 62/62′ that the weight of the liquid, when the holder is turned upside down, will not overcome the adhesive and cohesive forces and drive the cover slip 46 off of the holder.

It will also be appreciated that in some embodiments, a cover slip may be used which rests on the plurality of corner pieces 44 instead of being confined to the square area defined by the corner pieces 44.

FIGS. 9 to 12 depict a holder 110 for a hole-type cell carrier 112. Like holder 10, holder 110 may be made for example from plastic, e.g. polystyrene, polycarbonate, polymers of acrylic acid and acrylic acid derivatives (e.g. polyacrylates and poly(meth)acrylates), and polydimethylsiloxane, as well as co- and terpolymers made from at least one of the monomers used to make these polymers, such as acrylonitrile styrene acrylate (ASA), for example by injection molding.

As shown in the figures, a hole-type cell carrier 112 may be mounted in the center of a platform 152 formed in the upper face 114 of holder 110, although it will be appreciated that holders without cell carriers mounted thereon are provided in accordance with some embodiments of the invention. It will also be appreciated that while the holes 116 in cell carrier 112 are depicted schematically as being arranged in a square array, in general the holes in a cell carrier need not be in a square array. Furthermore, although the holes 116 in cell carrier 112 are depicted only schematically and are not drawn to scale, the depiction of holder 110 is drawn to scale. Thus, holder 110 is approximately 3 cm long×3 cm wide×1 cm deep. As shown in the figures, cell carrier 112 is of a generally circular shape, having a square array of holes in the center thereof, and therefore holder 110 has a hole 118 of generally circular cross section into which cell carrier 112 may be inserted. In order to properly align cell carrier 112 relative to holder 110, and in some embodiments to hold cell carrier 112 in place and at the same time prevent unwanted rotation of cell carrier 112 relative to holder 110, cell carrier 112 is formed with several small indentations around the circumference thereof, and a plurality of tabs 120 are formed in holder 110 to fit into the indentations in cell carrier 112 and thus hold cell carrier 112 in a stable rotational position relative to holder 110. However, it will be appreciated that the upper aperture of hole 118 may be formed so as to accommodate a cell carrier of a different shape, and that other mechanisms besides the indentation/tab mechanism may be used to maintain the holder and carrier in a fixed configuration relative to one another. It will be appreciated that in those embodiments in which tabs 120 are used to hold cell carrier 112 in place, the tabs will extend slightly over the upper surface of cell carrier 112, without occluding any of the holes of cell carrier 112.

Hole 118 consists of three coaxially arranged portions. A lip 121, upon which carrier 112 rests, defines the uppermost portion of hole 118. Lip 121 is spaced from platform 152 just enough to allow the upper surface of cell carrier 112 to reside at substantially the same height as the surface of platform 152. The lip is designed so that only an outer part of cell carrier 112 will rest thereupon, and thus lip 121 will not occlude the holes in cell carrier 112 or obstruct viewing of cells contained in cell carrier 112. It will be appreciated that in some embodiments, carrier 112 may be affixed to lip 121, for example by use of an adhesive or by ultrasonic welding, in which case in some embodiments tabs 120 may be foregone. The middle portion of hole 118 is of narrower diameter than the uppermost portion of hole 118, and has an upper cylindrical portion and a deeper frusto-conical portion that narrows to the lowermost portion of hole 118, which is (i) cylindrical (ii) the portion of hole 118 of narrowest diameter, and (iii) in fluid communication with cavity 122, which is located in the interior of holder 110. The roof 124 of cavity 122 is defined by the body of holder 110. It will be appreciated that in contrast to the embodiment shown in FIGS. 1 to 8, in the embodiment shown in FIGS. 9 to 12, a circumferential ridge 126 protrudes from roof 124 and both surrounds and defines the lowermost portion of hole 118. Roof 124 tapers up from the upper edge 127 of circumferential ridge 126. Together, circumferential ridge 126 and the taper of roof 124 reduce the likelihood of bubbles of air entering hole 118 once cavity 122 has been filled with a liquid, with the taper directing bubbles of air or other gas which may become trapped in cavity 122 to ascend away from the center of the cavity, and thus not interfere with illumination or irradiation of carrier 112.

As seen in plan view from the bottom, cavity 122 is of generally circular cross-section, although on two opposite sides thereof, the walls of cavity 122 have flattened portions 125 and 125′. The curved portions of the walls of cavity 122 open to ports 128 and 128′. Ports 128 and 128′ open to faces 130 and 130′ respectively of holder 110 and thus, when plugs 132 and 132′ (which are analogous in shape, construction and function to plus 32 and 32′) are not present in ports 128 and 128′, ports 128 and 128′are in fluid communication with the exterior.

The floor 134 of cavity 122 is defined by the top surface of a covering 136. Covering 136 may be manufactured separately from the rest of holder 110 and emplaced within an aperture 138 formed by rim 140 in the bottom of holder 110, whereby to seal off cavity 122 from the underside 142 of holder 110. Covering 136 may be held in place by pressure, for example if the diameter of cover 136 is slightly larger than that of aperture 138, in which case covering 136 may if desired be removed from holder 110 after use, or covering 136 may be held in place, e.g. using an adhesive or by ultrasonic welding. Covering 136 may be made of any suitable material, and thus may but need not be made of the same material as the rest of holder 110, and thus may for example be made by injection molding. The area of covering 136 which, when covering 136 is emplaced, is aligned beneath the holes of cell carrier 112, is transparent to the frequency of electromagnetic radiation used to illuminate the cells in cell carrier 112. Alternatively, covering 136 may be formed integrally with the rest of holder 110. Optionally, words may be formed in covering 136.

The top of covering 136, i.e. floor 134 of cavity 122, tapers down from its center. Thus, taking into account the shape of the top of cavity 122, as seen in FIG. 10, in cross-sectional view cavity 122 is of generally concave shape. This means that holder 110 may be flipped-over, so that face 114 faces the floor of a laboratory rather than the ceiling, and used for viewing cells, for example in an inverted microscope, and in either the face 114-up position or the face 114-down position, air bubbles within cavity 122 will ascend away from the center of the cavity.

As shown in the figures, in use plugs 132 and 132′ are placed in ports 128 and 128′, respectively, and in some embodiments of the invention a holder comprises plugs as well, although it will be appreciated that plugs per se are not part of the invention. Plugs 132 and 132′, like plugs 32 and 32′, are of a generally open cylindrical shape, with a beveled edge on the exterior of the closed side, so that when fitted into ports 128 and 128′, the closed ends of plugs 132 and 132′ are close to cavity 122 and seal cavity 122 from faces 130 and 130′ respectively. Plugs 132 and 132′, like plugs 32 and 32′ are made from a flexible material, e.g. rubber, silicone or a thermoplastic elastomer. In order to fill cavity 122 with liquid, e.g. a nutrient solution for cells on cell carrier 112, a liquid may be injected through one of the plugs into cavity 122. Because cavity 122, via hole 118, is in fluid communication with the exterior, as cavity 122 fills with liquid, air within hole 118 will exit via hole 118; in those cases in which a cell carrier is emplaced in hole 118 and affixed to lip 121, the air will exit via the holes of the cell carrier. If it is desired to change the liquid in cavity 122, old liquid may be withdrawn through one plug and simultaneously or thereafter new liquid may be injected through the other plug. Injection of liquid through the plugs may be accomplished e.g. by inserting a needle through the relevant plug. Alternatively, in some embodiments, plugs 132 and 132′ have a small slit in the middle thereof, so that a syringe may be used to inject liquid, without resort to a needle, for example by placing the syringe over the slit. In such cases, the plugs are constructed such that application of pressure to the syringe will force the liquid in the syringe through the slit. Upon cessation of the pressure and cessation of fluid flow from the syringe, the slit self-seals. Plugs 132 and 132′ may be held in place by pressure between the walls of plugs 132/132′ and the walls of ports 128/128′, respectively, or plugs 132/132′ may held in place e.g. using an adhesive or by mechanical means.

Although a cell carrier 112 may be loaded with living cells prior to emplacement in hole 118, in general the cell carrier will first be emplaced in the holder, and then loaded with living cells. Such loading may be accomplished, for example, by placing plugs in ports 128 and 128′; injecting sufficient solution into cavity 122 to at least fill the bottom of hole 118, preferably to completely fill hole 118 up to cell carrier 112; applying pressure on the plugs, whereby to decrease the volume of cavity 122—in accordance with some embodiments sufficiently decreasing the volume to bring the solution into contact with the lower surface of cell carrier 112 if it is not already in contact therewith, in accordance with some embodiments sufficiently decreasing the volume to completely cover the upper surface of cell carrier 112 with the solution; placing a drop of cell-containing solution on the top surface of cell carrier 112; and releasing the pressure on the plugs whereby to increase the volume in cavity 122 to its previous state and thus create a pressure differential and draw the cell-containing solution through the cell carrier, whereby to load the cell carrier with cells.

As stated above, it is often desired to contact the cells on the cell carrier with a liquid, for example to expose the cells to a solution containing a stimulus, to stain the cells, or to wash the cells after staining the cells or exposing the cells to a solution containing a stimulus. Cell carriers held in a holder 110 may be washed or otherwise contacted with a liquid by methods known the art. However, as will now be explained, holder 110 facilitates very gentle washing of cells, or other contacting of cells with a liquid, using a minimum of washing solution and without having to move the cell carrier and/or the holder from e.g. a microscope platform, by taking advantage of capillary action. At the corners of upper face 114 of holder 110 there are a plurality of raised corner pieces 144, each of which contains a pair of faces 145 and 145′ which are mutually perpendicular, thus defining a 90-degree angle, and which are also perpendicular to ledge 143, so that the corner pieces collectively define the corners of a square. In a manner similar to that in which cover slip 46 is used, cover slip 146, which is made of any suitable material which is transparent to the electromagnetic radiation used to illuminate the cells, such as glass or plastic, may thus be placed within this square, and the presence of corner pieces 144 will prevent lateral or rotational movement of cover slip 146 relative to face 114 of holder 110. It will be appreciated that although the figures show a holder in which corner pieces 144 have been fabricated to hold a cover slip of a particular size, holders in accordance with embodiments of the invention can readily be made to hold cover slips which differ in size from cover slip 146. Moreover, it will be appreciated that instead of corner pieces 144, a plurality of ridges (not shown) may be formed on surface 114 along the perimeter of holder 110 or in close proximity to the perimeter, which will prevent lateral or rotational movement of cover slip 146 relative to face 114. A pair of ridges 148 and 148′, raised to the same height above platform 152 as ledges 143, generally in the range of from 0.01 mm to 0 5 mm height, rise above platform 152 on either side thereof and support cover slip 146 and space cover slip 146 from the surface of platform 152. Similarly, near one end of platform 152, ridge 149 is aligned with ledges 143 and rises above platform 152 to the same height as ledges 143 to support cover slip 146. It will be appreciated that although in some embodiments of the invention, a holder is provided with a cover slip, the cover slip is not necessary in all embodiments of the invention, and cover slips per se are not part of the invention.

As shown in FIG. 9, part of each of ridges 148 and 148′ is located above cavity 122, but ridges 148 and 148′ are spaced inwardly from the outermost edges of the walls which define two of the sides of cavity 122. As a result, a pair of gutters 150 and 150′ are formed in the upper side of holder 110, running along either side of platform 152 along nearly its entire length and generally perpendicular to faces 30 and 30′. In contrast to troughs 50 and 50′ in holder 10, in holder 110 the presence of gutters 150 and 150′ is not required in order to enable washing of the cell carrier 112, and in principle the outer sides of ridges 148 and 148′ could be located above the outermost edges of the walls which define two of the sides of cavity 122, thus eliminating the presence of gutters 150 and 150′. Near face 130, an oblong indentation 154 is formed in platform 152. Indentation 154, which is sized to hold a small quantity of liquid, is positioned so that when cover slip 146 is put in place, part of indentation 154 will be covered by cover slip 146 and part will not be. In some embodiments, at least half of indentation 154 will be covered by cover slip 146. Thus, when cover slip 146 is placed on ridges 148, 148′ and 149, and indentation 154 is then filled with a liquid, usually a washing or staining solution, the liquid will be drawn by capillary action from indentation 154 along platform 152 in the direction of cell carrier 112. The presence of ridges 148, 148′ ensures that as the liquid moves along platform 152, it remains in the space between platform 152, ridges 148, 148′ and cover slip 146. In this manner, when a cell carrier 112 is emplaced in holder 110, the liquid will pass over the surface of cell carrier 112 and contact the cells in the cell carrier, for example to wash the cells.

Once liquid has passed over cell carrier 112, it will continue in its path along platform 152. However, near face 130′, on both sides of platform 152, each of ridges 148 and 148′ ends, and platform 152 widens into protrusions 156, 156′, 158 and 158′, which extend toward faces 160 and 160′, respectively. Thus, platform 152 is relatively narrower in the regions between protrusions 156/158 and protrusions 156′/158′ than at the tips of the protrusions, the protrusions on either side effectively forming semicircular edges 159 and 159′, the tips of which project from the rest of platform 152. At the end of platform 152, and adjacent to protrusions 158 and 158′, is ridge 149. As a result of this construction, when liquid flowing past cell carrier 112 reaches the region of protrusions 156/158 and 156′/158′, it begins to collect in the space between edges 159 and 159′ and cover slip 146, and then begins to creep beyond edge 159, edge 159′ or both. When enough liquid has collected in the area beyond edge 159 and/or 159′ to form a droplet of sufficient mass that gravitational forces overcome adhesive forces between the droplet and cover slip 146, the liquid begins to flow down semi-tube 164 and/or semi-tube 164′ into well 162 and/or well 162′. This ensures a continuous flow of liquid from indentation 154 into wells 162/162′, until the liquid in indentation 154 is substantially depleted, thus enabling washing of cells in cell carrier 112. As depicted in the figures, each of wells 162/162′ can hold approximately 1000 microliters of liquid. This enables numerous washings of the cell carrier of e.g. 10 to 30 microliters per wash, although it will be appreciated that holder 110 may be formed in accordance with embodiments of the invention which hold different amounts of liquid.

As shown in the figures, the holder 110 contains an indentation 166 formed approximately mid-way along face 160. Indentation 166 facilitates handling of cover slip 146.

Although washing of a cell carrier as described above may be carried out only when the holder is in the upright position, viz. when platform 152 faces upward, as stated above, the bottom of cavity 122 is formed so that if the holder is inverted, for example for use with an inverted microscope, air within the cavity will stay near the circumference of the cavity, away from the center area where the cells are illuminated and through which they are viewed. It will be appreciated that when the holder is turned upside-down, adhesive and cohesive forces due to liquid in the space between cover slip 146 and platform 152 will hold the cover slip in place, provided that a sufficiently small amount of liquid is present in wells 162/162′ that the weight of the liquid, when the holder is turned upside down, will not overcome the adhesive and cohesive forces and drive the cover slip 146 off of the holder.

FIGS. 13-25 depict a holder 210 for a hole-type cell carrier, constructed and operativve in accordance with embodiments of the invention. As shown in the figures, holder 210 is approximately the length and width of a standard microscope slide (about 75 mm×25 mm), and of a depth of approximately 10 mm. FIG. 13 shows in isometric view the upper side of cell carrier holder 210, including a cell carrier unit 212. FIG. 14 shows cell carrier holder 210 from the same vantage point, but in exploded view, so that cell carrier unit 212 and plunger element 214 are clearly visible as separate components. FIG. 14A is essentially the same as FIG. 14, but includes a cover slip. FIG. 15 shows the upper side of cell carrier 210 in plan view. Cell carrier holder 210 includes an upper face 216, a first recessed face 218 and a second recessed face 220, which is located geometrically within platform 219, which is portion of first recessed face 218 between ridges 234, the function of which will be explained below. First recessed face 218 is parallel to upper face 216 but spaced apart therefrom, whereby to form a first recessed region 222; similarly second recessed face 220 is parallel to first recessed face 218 but spaced apart therefrom, whereby to form a second recessed region 224, in order to accommodate cell carrier unit 212. It will be appreciated that although as shown in FIGS. 13, 14 and 15, first recessed face 218 is of a uniform distance from upper face 216, in practice platform 219 and the regions of face 218 outside ridges 234 need not necessarily be the same distances from upper face 216. As shown in FIG. 14, a hollow portion 226 is formed within the area of second recessed face 220 in alignment with the region where a cell carrier 228 will be located when cell carrier unit 212 is emplaced within second recessed region 224. Furthermore, cell carrier unit 212, carrying hole-type cell carrier 228, is formed so that the upper surfaces of hole-type cell carrier 228 and cell carrier unit 212 are aligned with one another, and when cell carrier unit 212 is emplaced in second recessed region 224, the upper surfaces of cell carrier unit 212 and hole-type cell carrier 228 are at substantially the same height as platform 219. It will also be appreciated that cell carrier unit 212 and hole-type cell carrier 228 may be formed integrally, examples of which will be explained in more detail below, or the two components may be formed separately and joined together before being inserted into cell carrier holder 210.

Along the longitudinal edges of first recessed region 222 there are formed a pair of ledges 230, the upward-facing faces 232 of which are at a height intermediate that of upper face 216 and first recessed face 218, as well as intermediate the height of platform 219 and upper face 216, if platform 219 is of a different height than the rest of first recessed face 218. Running generally in parallel longitudinally near the middle of first recessed region 222 from the proximal end thereof are pair of ridges 234, which near the distal end of first recessed region 222 taper in toward another. Ridges 234 rise to a height which is the same as that of faces 232. For reason which will be explained presently, the height of faces 232 and ridges 234 will generally be from 0.1 mm to 1 mm above that of platform 219.

With this construction, when a cell carrier unit 212 is emplaced within first recessed region 222, and a transparent cover slip 236 (shown only in FIGS. 14A, 16 and 16A) of substantially the same area as recessed region 222 is placed thereupon, there is formed between ridges 234 a thin, capillary cavity which is open at proximal end 238 and distal end 240. If, when a cover slip 236 is emplaced, a drop of liquid is placed in sub-region 242 of first recessed region 222, which is located at the proximal end of cell carrier holder 210 and remains open to the area above holder 210 even when a cover slip 236 is emplaced, the liquid will be drawn by capillary forces in the direction of distal end 240. In this way, cell carrier 228 may be exposed to a solution, e.g. a solution carrying a material intended to stimulate or stain one or more cells on cell carrier 228, or a washing solution to wash away a solution carrying such a material.

Near distal end 240 of first recessed region 222, approximately where ridges 234 reach their closest approach to one another, platform 219 tapers downward at 241 into recessed collection region 243. The location of this tapering 241 can be see more clearly in FIG. 16A, which is a cross-sectional view of holder 210 taken along line 16-16, and in FIG. 16B, which is an enlarged drawing of circled the portion of FIG. 16A. The bottom face 244 of recessed collection region 243 lies at a height significantly below that of platform 219. As a result, prior to reaching distal end 240 of first recessed region 222, liquid which is drawn by capillary forces from sub-region 242 toward distal end 240 will fall into recessed collection region 243. In particular, by virture of the construction shown, small drops of liquid will initially begin to collect on the cover slip above tapering 241, as well as along the edges 247a and 247b where the cover slip 236 contacts ridges 234 as they near their point of closest approach. When the mass of liquid collects to a mass sufficient so that gravity overcomes the capillary forces holding the liquid against the cover slip 236, the liquid begins to flow into recessed collection region 243. In this way, hole-type cell carrier 228—and thus cells held within hole-type cell carrier 228—may be repeatedly contacted with liquid, e.g. in order to stimulate or wash one or more cells on cell carrier 228. Because the amount of liquid required, for example to stimulate or wash the cells, is only a few microliters, and recessed collection region 242 holds several milliliters, many stimulations, washings and/or other contactings of the cells with such liquid may be effected.

Rising above upper face 216 at the corners of first recessed region 222 are four pairs of holding elements 245, the members of each pair being oriented orthogonally with respect to one another. Holding elements 245 ensure that when a cover slip 236 is emplaced, it does not move out of position. If the holder 210 is to be used in an inverted position (see discussion below), holding elements 245 ensure that cover slip 236 does not slide out of place as the holder 210 is being inverted. Cover slip 236 will generally be made of glass or of plastic, such as polystyrene or polylcarbonate, and will be transparent to the frequency of electromagnetic radiation being used to study the cells on cell carrier 228. Optionally, cover slip 236 may be held in place with a holding mechanism, such as a clip or pair of clips (not shown), or for example with glue.

As can be seen in FIGS. 17 and 18, which show isometric and plan views, respectively, of holder 210 viewed from the bottom, a lower cover piece 248, shown in FIG. 17 in exploded view, is attached to bottom face 250 of holder 210. Lower cover piece 248 may be made of any suitable material which is transparent to the frequency or frequencies of light used to study the cells on cell carrier 228; generally lower cover piece 248 will be made of glass or of plastic, e.g. polycarbonate or polystyrene and the like. As depicted in FIG. 17, lower cover piece 248 fits into recess 252. Lower cover piece 248 may be permanently emplaced in recess 252, for example by ultrasonic welding or using an adhesive. If an adhesive is used, a pair of recessed grooves 254 may be provided, to ensure that excess adhesive does not migrate toward the center of lower cover piece 248 and occlude the passage of light through cell carrier 228. When emplaced, the upper face of lower cover piece 248 abuts the lower edges of hollow portion 226. Thus when both lower cover piece 248 and cell carrier 228 are emplaced, they cover the upper and lower portions of hollow portion 226, thus forming a cavity 256. As will be explained presently, the presence of cavity 256 is useful inter alia for the loading of cells onto cell carrier 228. It will also be appreciated that if holder 210 is made as a single piece, e.g. by injection molding, lower cover piece 248 may be formed integrally with holder 210.

At one end of holder 210, near the proximal end of first recessed region 222 and running generally perpendicular to the longitudinal axis of holder 210, there is formed a transverse passageway 258, into which fits plunger element 214. As can be seen in FIG. 19, which shows in isometric view a cut-away view along the axis of passageway 258, along its length transverse passageway 258 is generally cylindrical, having a circular cross-section at any given point along its length. However, passageway 258 has two different diameters at different points along its length. For part of its length, passageway 258 has a first diameter D1; but at some point along its length, it narrows so that along the rest of its length, it is of smaller diameter D2. Partway along the length of passageway 258, in the region where passageway is of diameter D1, there is an opening 260 which constitutes one end of a micropassageway 262. As can be seen in FIG. 16, micropassageway 262, which as shown is of generally cylindrical cross-section but need not be so constrained in its cross-sectional shape (e.g. it may be of generally rectangular cross-sectional shape), continues to cavity 256, and thus transverse passageway 258 is in fluid communication with cavity 256 via micropassageway 262. In addition, as can be seen in FIG. 14, near the end of passageway 258 of larger diameter there is an opening 282 which allows passageway 258 to be in fluid communication with the exterior of the passageway. It will also be appreciated that, although as shown in FIGS. 14 and 21, hole 282 may be formed on the side of holder 210, in alternative embodiments hole 282 may be formed on the upper face of holder 210, for example as shown in FIG. 14A, in which hole 282 is also surrounded by a rim 283.

Plunger 214, which may be made of any suitable material such as plastics, elastomers or thermoplastic elastomers, is sized to fit into passageway 258 and like passageway 258 is of generally cylindrical construction. Plunger 214 is of smaller diameter near distal end 264 and continuing for part of its length; it is of larger diameter near proximal end 266. Near distal end 264 there is formed a recessed region 268 into which is inserted a first O-ring 270. Similarly, within the larger diameter section of plunger 214, near the point at which the diameter of plunger 214 changes from the larger to the smaller diameter, there is a formed a recessed region 272 into which is inserted a second O-ring 274. The O-rings may be made of rubber or another suitable material that will enable plunger 214, once inserted into passageway 258, to seal off the ends of passageway 258 from the interior of passageway 258. In an alternative embodiment, as shown in FIG. 26, if plunger 214 is formed from a thermoplastic elastomer or a similar material, e.g. polypropylene, polyethylene or a rubbery material, instead of O-rings 272 and 274, plunger 214 may be formed with skirts 273 and 275 respectively. Since in this case, the plunger is made of a thermoplastic elastomer, and has a small degree of flexibility, skirts 273 and 275 are sized so that, once plunger 214 is inserted into passageway 258, they seal off the ends of passageway 258 from the interior of passageway 258.

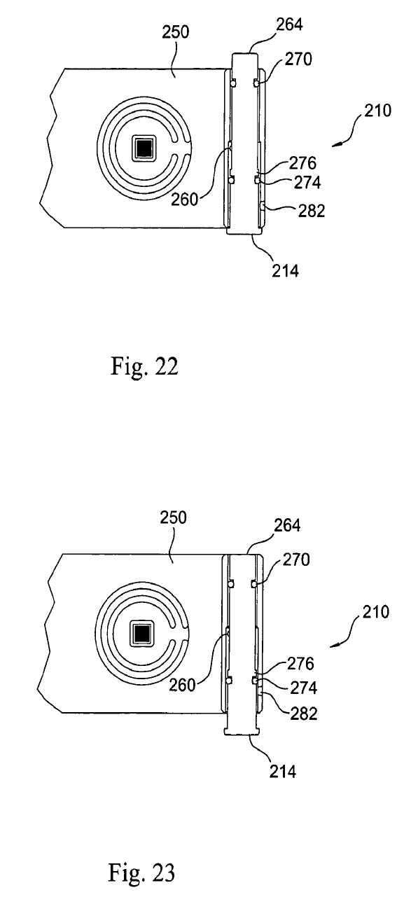

In accordance with some embodiments, plunger 214, passageway 258, micropassageway 262 and hole 282 may be used together to facilitate loading of cells onto cell carrier 228 as follows: first, as shown in FIG. 21, plunger 214 is inserted into passageway 258 from the opening of larger diameter and pushed inward, past opening 260, until O-ring 272 (or skirt 273) is inside the smaller diameter portion of passageway 258, and O-ring 274 (or skirt 275) is between hole 282 and end 284 of passageway 258. A liquid, such as a liquid containing medium on which cells can be grown, is then injected via hole 282 into the space between the wall of passageway 258 and plunger 214. The liquid will fill this space and then pass through micropassageway 262 into cavity 256. Once cavity 256 has been filled with liquid, plunger 214 is then inserted the rest of the way into passageway 258, until portion 276, which is at the proximal end of plunger 214 and of a diameter too large to be inserted into even the part of passageway 258 of larger diameter, stops further insertion; when this occurs, part of the smaller diameter section of plunger 214 will extend out the distal end 280 of passageway 258, as shown in FIG. 22. Because the two O-rings (or two skirts), when both are within passageway 258 and O-ring 274 (or skirt 275) is between hole 282 and hole 260, seal off the interior of passageway 258 from the exterior except via micropassageway 262, movement of plunger 214 in this manner through passageway 258 toward opening 260 causes O-ring 274 (or skirt 275) to move toward opening 260, resulting in a decrease in the volume between the walls of passageway 258 and plunger 214, thus forcing liquid through micropassageway 262 and into cavity 256. As plunger 214 is inserted, any air remaining within cavity 256 is forced out through the holes of cell carrier 228. By properly choosing the volume of cavity 256, the differences between the diameters of the different sections of passageway 258, the difference in diameters between the different sections of plunger 214, and the relative lengths of the sections, insertion of plunger 214 as far as possible into passageway 258 will result in O-ring 272 (or skirt 273) being adjacent to the distal end 280 of passageway 258 and cavity 256 being filled to the point that a small amount of liquid seeps through the holes of cell carrier 228 and onto the surface thereof. A drop of cell-containing fluid may then be loaded onto the hole-bearing surface of cell carrier 228. Pushing plunger 214 in the opposite direction, until the distal end 264 of plunger 214 is level with the side of holder 210 as shown in FIGS. 15, 17, 18 and 23, will result in negative pressure, causing liquid to be drawn from cavity 256 into micropassageway 262 toward passageway 258 and causing the drop of cell-containing fluid at the surface of cell carrier 228 to be drawn into the holes of cell carrier 228, thus facilitating loading of the cells on the cell carrier.

Cell carrier holder 210 may be made of any suitable material. Because of the presence of hollow portion 226, with which the holes of cell carrier 228 are aligned, it is not necessary for holder 210 to be transparent to the electromagnetic radiation of interest for imaging or viewing cells in the cell carrier, but in some embodiments holder 210 is transparent, being made of a suitable plastic such as PDMS, polycarbonate, polystyrene or the like. However, as stated above, lower cover piece 248 is transparent to the frequency or frequencies of light used to study the cells on cell carrier 228.

As shown in FIGS. 13, 14 and 15, in some embodiments, cell carrier holder 210 may be formed with one or more wells 284 at the distal end thereof, although the placement of wells 284 is not critical and in other embodiments they may be placed e.g. closer to the other end of collection region 243. These wells, if present, may be sized so as to hold, for example, small containers, e.g. small test tubes, which may contain fluids containing cells to be loaded on cell carrier 228 or fluids with which to wash, stimulate or otherwise contact cells contained on cell carrier 228.

As stated above, cell carrier unit 212 and cell carrier 228 may be formed as two separate units. However, as can be seen in FIG. 13 and in FIG. 24, which shows a cut-away view taken along the central longitudinal axis of cell carrier 212, cell carrier unit 212 and cell carrier 228 may be formed integrally as an essentially flat, square piece of material of approximately 0.1 mm to 1 mm thickness at the edges, with a hollow region 285 formed in the center thereof Above this hollow region, in an area of approximately 20 to 50 microns thickness, there are formed a plurality of holes 286 for trapping cells. In FIG. 13, the holes 286 are arranged in a square pattern; for ease of illustration, only the holes along one lengthwise and one widthwise edge of this square are shown in FIG. 13. FIG. 25 shows in expanded view several of these holes 286. As can be seen, each of the holes is formed of two coaxial cylinidrical sections, an upper section 288 and a lower section 290. The upper section is sized so as to enable a single cell of a chosen size to enter; the lower section, which is smaller in diameter than the upper section, is sized sufficiently small to ensure that the cell will be unable to pass therethrough. Typically, the diameter of the upper section will be chosen in the range from 10 and 50 microns, and the diameter of the lower section will typically be chosen in the range of from 0.5 to 10 microns. In some embodiments, all of the holes 286 are of the same dimensions; in other embodiments, one group of holes on a cell carrier will be dimensioned so as to trap cells of one size, and another group of holes on the same cell carrier will be dimensioned so as to trap cells of another size. It will be appreciated that in such cases, the larger cells will be loaded first. It will also be appreciated that the holes need not be cylindrical. Shown in plan view in FIG. 26 are 16 holes from a hole-type cell carrier constructed in accordance with an alternative embodiment, in which the upper part of each hole has a triangular cross-section large enough to circumscribe a circle of e.g. 10-50 microns diameter, and the lower part of each hole, which is located in the corner of the triangle relative to the upper part of the hole, is cylindrical with a diameter of e.g. 0.5 to 10 microns. The use of holes having an upper triangular portion is useful when imaging cells in the hole, since the shape of the cell is readily distinguished from the shape of the upper part of the hole.

An integrally formed cell carrier unit/cell carrier of the type shown in FIGS. 13 and 24 may be formed in a number of ways. For example, to make such units in a square shape having a length of 1-2 mm the side, the top of a silicon substrate about 10 to 15 cm diameter may be coated with a first thin layer of SU-8, an epoxy-based photoresist (see e.g. http://www.microchem.com/products/su_eight.htm). As is known in the art, SU-8 may be used as a negative photoresist, i.e. the material only polymerizes where exposed to polymerizing radiation. The SU-8 layer may be masked to make small wells, exposed, and developed to yield small cylindrical wells of 0.5-10 microns diameter. A thicker layer of SU-8 may then be applied above the existing layer of SU-8. This second SU-8 layer may be masked to make larger wells, for example which are cylindrical of 10-50 microns diameter and concentric with the smaller wells; or which as explained above may be e.g. triangular and large enough to circumscribe a circle 10-50 microns diameter, with one or more of the initially formed small wells in the corner or corners of the triangle. The second SU-8 layer is then exposed and developed to leave wells having small lower sections and larger upper sections. After the formation of these wells, the silicon on the opposite side of substrate in the center of the substrate may be etched (wet or dry etching) until the SU-8 layer is exposed, thus opening the bottoms of the wells and turning them into holes 286. Individual cell carrier units 212 each having a cell carrier 228 integrally formed therewith may then be cut from the silicon substrate, for example by dry or wet chemical etching, in a manner analogous to methods known in the art of semiconductor chip fabrication.

Another method for making an integrally formed cell carrier unit/cell carrier of the type shown in FIGS. 13 and 24 is to start with a silicon substrate, and to mask then then etch the upper surface of the substrate so as to form wells of a predetermined depth and of a predetermined cross dimension, for example, if cylindrical, of diameter 10-50 microns. The upper surface of the substrate, which now contains wells, may then be coated with a thin, e.g. 2 micron thick, coating of silicon dioxide. Using masking and lithography techniques, such as those known in the art, wells of smaller cross dimension may then be formed in the bottom of the existing SiO₂-coated wells. Then, analogously to the previously described technique, the silicon on the opposite side of substrate in the center of the substrate may be etched (wet or dry etching) until the SiO₂ layer is exposed, thus opening the bottoms of the wells and turning them into holes 286. Individual cell carrier units 212 each having a cell carrier 228 integrally formed therewith may then be cut from the silicon substrate, for example by chemical or laser etching, in a manner analogous to methods known in the art of semiconductor chip fabrication.

Another method for making a cell carrier of the type shown in FIGS. 13 and 24 is by stamping a substrate, e.g. a polydimethylsiloxane (PDMA) or polycarbonate substrate. In this technique, two complementary stamps are formed, e.g. from nickel, which when pressed together with the substate in between, will result in a cell carrier. In some embodiments, the substrate may be a fluorinated polymer (e.g. polytetrafluoroethylene (PTFE, Teflon®)) having the same refractive index as water, which facilitates improved imaging of the cells on the carrier.

Although washing of a cell carrier as described above may be carried out only when the holder is in the upright position, viz. when platform 219 faces upward, as stated above, holder 210 may also be used when inverted. It will be appreciated that when holder 210 is turned upside-down, adhesive and cohesive forces due to liquid in the space between cover slip 236 and platform 219 will hold the cover slip in place, provided that liquid has been emptied from collection region 243 before inverting holder 210.

Loaded cell carriers mounted on a holder in accordance with embodiments of the present invention may be viewed as is known in the art, for example using a CellScan® device, available from Cell Kinetics Ltd., Lod, Israel.

Referring now to methods of loading a hole-type cell carrier and structures for implementing such methods, which methods and structures may in some embodiments be used in conjunction with the holders described hitherto but need not necessarily be used in conjunction with such holder, FIGS. 27A, 27B and 27C (collectively referred to as FIG. 27) show schematically in cross-section a cell carrier 310, constructed and operative in accordance with some embodiments of the invention. The carrier contains a plurality of holes 312, arranged in an organized manner that allows the assigning of an address to each hole. Each hole has a first opening 314 formed in a first outer surface 316 of carrier 310 and a second opening 318 formed in a second surface 320 of carrier 310. Opening 314 is large enough allow a single cell to pass therethrough but not large enough to allow two cells to pass through, and each hole is large enough to accommodate a single cell therein but not more than one cell therein. In this connection, it will be appreciated that different types of cells have different average sizes, and thus a cell carrier that is suitable for use with large cells (e.g. of average diameter 16-20 microns) may not be suitable for use with smaller cells (e.g. of average diameter 7-10 microns), and it is to be understood that in practice, the hole size and shape in the cell carrier will be chosen in accordance with the type of cell to be studied.

As depicted in FIG. 27, each hole is structured so that it narrows to a cross-sectional dimension (length and/or width, or in the case of a circular cross-section, diameter) too small for a cell to pass through and, and at a point 321 between surfaces 316 and 320, the hole narrows into a capillary-like portion 322. In the context of the present application, the term “capillary-like” refers to a passage of sufficiently narrow diameter or thickness that it is capable of drawing an aqueous and/or a cell-containing medium therethrough by capillary action. In the context of hole-type cell-carriers, where the widths of the cells of interest are generally on the order of 7-20 microns, the capillary-like portions 322, which will generally have a maximum width of not more than 10 microns, need not be very long in order to draw liquid therethrough, in principle only a few microns. Furthermore, when cells are loaded on such cell carriers from the top, as will generally be the case, loading will be accomplished with, not against, gravity, further shortening the necessary length of capillary-like portions 322. Hence such cell carriers may be made with sufficient thickness to impart stability to the carriers, without sacrificing ability to utilize capillary action to load the carriers.

In some embodiments, the holes, as a group, are designed and constructed such that individual cells contained within the holes reside substantially in a single plane, thus simplifying the process of viewing the cells. It will be appreciated that in the context of this application, the term “view” or “viewing” refers not only to viewing in the visible light spectrum, e.g. by the human eye or by an optical device, but to any type of situation in which electromagnetic radiation is passed through a cell in a carrier in order to elicit information about that cell, such as but not limited to imaging or other observation or measurement; to stimulate the cell; to damage the cell; or to modify the cell, e.g. by inducing a chemical reaction within the cell. It will also be appreciated that a cell need not fit completely within a hole, and that a portion of a cell may extend out of a hole. Thus, in some embodiments, the holes completely contain single cells, while in other embodiments, the holes partly contain single cells, from at least 50% of each cell up to 100% of each cell. Furthermore, it will appreciated that while, as shown in FIG. 27, the upper portion of the holes (above 321) has a generally convex shape, in the art various shapes for holes of hole-type cell carriers are known, and in practice the upper portion of each hole may have any suitable shape. For example, the upper portion of the hole may have a generally concave shape, a generally conical shape, a generally cylindrical shape, or a shape in which a portion of the wall of the hole is essentially flat.

As depicted in FIG. 27, capillary-like portion 322 extends to surface 320. As shown in FIG. 27A, surface 320 itself defines the upper face of a thin, capillary-like passageway 324 through carrier 310, which extends to surface 326. As can be seen in FIG. 27B, which shows the carrier of FIG. 27A looking along axis A′-A′ in accordance with some embodiments, in some embodiments there are a plurality of passageways 324, into each of which each member of a single row of holes 312 opens. As shown in FIG. 27C, which shows the carrier of FIG. 27A looking along axis A′-A′ in accordance with other embodiments, in other embodiments passageway 324 is a single thin layer, into which all holes 312 open. As a result of either construction shown, cell-containing solution which is loaded on surface 316 will initially be drawn by gravitation into the upper portions of the holes, provided that surface 316 is made from or coated with a material that sufficiently reduces the surface tension of the solution to enable the solution to be drawn into the upper portions of the holes. Thereafter, upon entering the capillary-like portions 322, the solution will be drawn via capillary action though the holes. The surfaces of passageway(s) 324 are sufficiently close to openings 318 that solution exiting from openings 318 will contact the surfaces of passageway(s) 324 and by virtue of such contact will be drawn further through passageway(s) 324 toward the outer surface 326. The construction shown in FIG. 1 is thus a capillary-action inducing structure, i.e. a structure that induces movement of solution therethrough by capillary action. By choosing an appropriate combination of lengths of capillary-like portions 322 and passageway(s) 324, a sufficient amount of solution will be drawn through the holes by virtue of capillary forces that cells will be drawn into the holes, one cell per hole. Thus in some embodiments, application of a vacuum to load the cells is unnecessary. In some embodiments, the capillary forces may be supplemented by the application of a vacuum during and/or the maintaining of a vacuum after loading of cells. In some embodiments, the capillary forces may be supplemented by constructing the cell carrier from, or coating the holes with, material to which the cells are adherent.

As shown in FIG. 27, capillary-like portions 322 extend all the way to second surface 320. However, in some embodiments of the invention, the capillary-like portions of the holes extend part-way toward second surface 320, then widen again before reaching surface 320. An example of this is marked as 322′ in FIG. 27A.

Carriers having capillary-like portions 322 or 322′ as shown in FIG. 27 may be fabricated, for example, by injection molding, if the carrier is to be made of plastic; by photoetching; by electroforming; by using a laser to etch holes in a glass substrate; or by other suitable methods which will be apparent to the skilled artisan. Thus, for example, as shown in FIG. 29A, if the carrier is to be made of plastic, a template can be made by applying a first photoresist 342 to a nickel substrate 340, leaving a plurality of exposed areas 344 in the photoresist. As shown in FIG. 27B, nickel is then electrodeposited at the open areas 44, resulting in build-up of nickel 346. As shown in FIG. 29C, when the electrodeposition has progressed sufficiently, a second photoresist layer 348 is applied, to leave exposed only a very small area 350 at the top of each previously deposited mound of nickel 346, and, as shown in FIG. 29D, a small additional amount of nickel 352 is then electrodeposited at each area 350. The photoresist is then removed to leave a nickel template, as shown in FIG. 29E. As shown in FIG. 29F, the nickel template is then inserted into a mold. The combined template and mold is then used for injection molding of e.g. polystyrene or polycarbonate to yield a carrier. In some embodiments, the carrier is made of a material which is transparent in the visible spectrum, the ultraviolet spectrum, or another portion of the electromagnetic spectrum of interest. Examples of such materials are polycarbonate, polystyrene, styrene acrylonitrile, and polyacetal.

As shown in FIG. 27D, it will also be appreciated that cell carriers such as those shown in FIGS. 27B and 27C may be constructed, for example, from two pieces, an upper piece 328 (which is similar to that shown in FIG. 28 and described in connection therewith) in which holes 312 are formed, including capillary portions 322, and a lower piece 330, which is essentially a flat piece having raised edge portions 332 which are raised just enough so that when pieces 328 and 330 are attached to one another, for example with an adhesive or by ultrasonic welding, passageway 324 is formed.

FIG. 28 shows schematically in cross-section a cell carrier 410, constructed and operative in accordance with some embodiments of the invention. The carrier contains a plurality of holes 412, arranged in an organized manner that allows the assigning of an address to each hole. Each hole has a first opening 414 formed in a first outer surface 416 of carrier 410 and a second opening 418 formed in a second surface 420 of carrier 410. Opening 414 is large enough to allow a single cell to pass therethrough but not large enough to allow two cells to pass therethrough, and each hole is large enough to accommodate a single cell therein but not more than one cell therein. As depicted in FIG. 28, each hole is structured so that it narrows to a diameter too small for a cell to pass through and, at a point 421 between surfaces 416 and 420, the hole narrows into a capillary-like portion 422. As depicted in FIG. 28, capillary-like portion 422 extends to surface 420, although it will be appreciated that the capillary-like portion need not extend completely to surface 420.

As shown in FIG. 28, adjacent to and contacting surface 420 is a layer of absorbent material 428. Liquid that passes through the holes 412, upon contact with the absorbent material, is absorbed into the absorbent material. Thus liquid will continue to flow through holes 412 as long as the absorbent material is in contact with surface 420 and as long as the absorbent material has not become saturated. The thickness of the layer of absorbent material 428 may vary in accordance with the absorbance requirements, so that, in accordance with different embodiments of the invention, the layer of absorbent material 428 may be thinner than cell carrier 410, of approximately the same thickness as cell carrier 410, thicker than cell carrier 410 or even substantially thicker than cell carrier 410. Absorbent material 428 may be any suitable absorbent material that absorbs the liquid used to load the cells.

As a result of the construction shown, cell-containing solution which is loaded on surface 416 will initially be drawn by gravitation into the upper portions of the holes, provided that surface 416 is made from or coated with a material that sufficiently reduces the surface tension of the solution to enable the solution to be drawn into the upper portions of the holes. Thereafter, upon entering the capillary-like portions 422, the solution will be drawn via capillary action though the holes, and will continue to be drawn through holes 412 as the solution is absorbed into absorbent material 428. The layer of absorbent material thus acts as a capillary-action inducing structure. Cells will thus be drawn into the holes, one cell per hole, and in accordance with some embodiments, the loaded cells will be held in place by capillary forces. Thus in some embodiments, application of a vacuum to load the cells is unnecessary. In some embodiments, the capillary forces may be supplemented by the application and/or maintaining of a vacuum. In some embodiments, the capillary forces may be supplemented by constructing the cell carrier from, or coating the holes with, material to which the cells are adherent.

In some embodiments, the absorbent material 428 is permanently affixed to the carrier 410. In other embodiments, the absorbent material is removable, so that after loading of the cell carrier, the absorbent material may be removed, thus facilitating viewing of the cells in the carrier with which the absorbent material would interfere were the absorbent material present during viewing.

It will also be appreciated that the cell carrier may optionally be coated with a biologically active material, such as a protein, peptide, nucleic acid, or biologically active small molecule (such as a small molecule hormone, avidin or biotin). Such a material may, for example, promote or inhibit cell adhesion or proliferation, or it may induce a reaction, such as the production of an observable marker, within cells which have a particular property, for example which have been successfully transfected with a particular gene.

As stated above, some (but not all) of the embodiments pertaining to the use of capillary-like structures for cell loading may be used in conjunction with the cell carrier holders described above. Thus, for example, an absorbent material may be used to load a hole-type cell carrier that has been or is to be emplaced in a holder such as that shown in FIG. 1, FIG. 9 or FIG. 13. It will be appreciated that in such a case, unless the absorbent material is transparent to the frequency of light used to view the cells, the absorbent material should be removed from beneath the cell carrier prior to viewing cells.

It will be appreciated that the invention is not limited by the embodiments shown in the figures, and that other variations will be readily apparent to those skilled in the art upon reading this description.

We claim:

1. A holder for a hole-type cell carrier, the holder comprising:
a body;
an elongate platform on said body, said platform having sides and a first and a second end;
a first hole located within said platform, into which a hole-type cell carrier can be emplaced so that a first surface of said hole-type cell carrier is substantially level with said platform;
first and second flow-stopping structures arranged longitudinally on either side of said platform, each of said first and second flow stopping structures arranged at a height different than the level of said platform, each of said first and second flow stopping structures beginning closer to said first end of said platform than said first hole and terminating closer to said second end of said platform than said first hole;
a first chamber formed in said body, said first chamber being located in fluid communication with said first hole at an end of said hole opposite to said platform;
at least one well located adjacent to said platform, said well being of greater depth than said first hole and sized to contain a greater volume of fluid than said first hole;
at least one of said flow-stopping structures terminating at a location so as to provide at least one opening where a fluid flowing over said platform can flow into said well; and
at least one support structure capable of supporting a cover slip over said platform and spacing said cover slip from said platform at a distance which, when a liquid is place between said platform and said cover slip, will enable capillary flow of said liquid between said platform and said cover slip.

2. A holder according to claim 1, further comprising a structure for changing the pressure in said first chamber.

3. A holder according to claim 2, wherein said structure for changing the pressure in said first chamber comprises either one of at least one port in said first chamber and a flexible plug in said port, or a second chamber which is in fluid communication with said first chamber and a plunger which fits into said second chamber so as to seal the interior of said second chamber and which may be moved therewithin so as to change the volume of the portion of the interior of said second chamber.

4. (canceled)

5. A holder according to claim 1, wherein either at least one of said flow-stopping structures is a ridge which rises above said platform and functions as said support structure or as part of said support structure, or at least one of said flow-stopping structures is in the form of a trough arranged on a side of said platform.

6-9. (canceled)

10. A holder according to claim 1, wherein said well is adjacent to one end of said platform, the juncture between said platform and said well being characterized by a declination from the platform into the well, said flow-stopping structures terminating at the edge of said well and closely approaching each other in the vicinity of said juncture.

11. (canceled)

12. A holder according to claim 1, further comprising at the first end of said platform a loading structure for loading fluid onto said platform.

13. A holder according to claim 12, wherein said loading structure is a depression formed in said platform and located so that, when a cover slip is placed over said platform between said retaining structures, part of said depression is covered by said cover slip and part is not.

14-15. (canceled)

16. A holder according to claim 1, further comprising an absorbent material which is located so that, once a hole-type cell carrier is emplaced in said holder, said absorbent material will be in sufficient proximity to the underside of said cell carrier to absorb liquid which exits from the holes of said hole-type cell carrier.

17-20. (canceled)

21. A holder suitable for use with a hole-type cell carrier, the holder comprising:
a first face, the first face having thereupon a platform, said platform having sides and a first and a second end, a first hole in which a cell carrier can be mounted being formed within said platform, troughs arranged on either side of said platform, each of said troughs being connected to a well of greater depth than the trough to which the well is connected, a depression being formed in said platform between said first hole and said first end of said platform, and between said first hole and said second end of said platform a pair of spaced apart branches extending laterally from said platform, one of said pair of branches extending in the direction of one of said wells and the other of said pair of branches extending in the direction of the other of said wells, the spacing between each pair of branches increasing along the length of the branches, and, between each respective pair of branches, a declination from said platform into each respective well.

22. A holder according to claim 21, wherein said first hole is in fluid communication with a cavity defined in the body of said holder.

23. A holder according to claim 22, wherein the roof of said cavity is shaped so that the lowest point of said roof is along the edge where said cavity meets said first hole, and the perimeter of said cavity along said roof is higher than said edge where said cavity meets said first hole.

24. A holder according to claim 22, wherein at least one port, capable of receiving a plug therein, runs through the walls of said cavity to the exterior walls of said holder to allow said cavity to be in fluid communication with the outside.

25. A holder according to claim 24, wherein a plug is present in each port of said at least one port and the plugs collectively seal said cavity from said exterior walls of said holder.

26. A holder according claim 22, wherein the floor of said cavity is shaped so that the highest point of the floor is aligned with said first hole, and the perimeter of said cavity along said floor is lower than said highest point of said floor.

27. (canceled)

28. A holder according to claim 21, wherein said holder further comprises a first plurality of ridges which extend to a uniform height which is above the level of said platform, such that when a cover slip is placed upon said ridges so that said cover slip covers said platform and a portion of said depression, liquid which is placed into said depression will move in the space between said cover slip and said platform in the direction of said branches by virtue of capillary forces.

29-31. (canceled)

32. A holder suitable for use with a hole-type cell carrier, the holder comprising:
an upper face, the upper face having thereupon a first platform, said platform having sides and a first and second end;
a first hole in which a cell carrier can be mounted being formed within said first platform;
first and second ridges, having proximal and distal ends, arranged longitudinally on either side respectively of said first platform;
a third ridge arranged transversely near a first end of said first platform;
said first, second and third ridges rising to a uniform height above the level of said first platform;
a depression formed near a second end of said first platform, such that said first hole is located between said depression and said third ridge;
said distal end of said first ridge being located between the longitudinal position of said hole and said third ridge;
a first well which is formed in the holder in the region adjacent to the side of said first platform upon which said first ridge is located, and which extends to a depth below the level of said first platform;
said first platform being shaped so that, in the region of said first platform which is located between said third ridge and said distal end of said first ridge, said first platform has at least two maximal widths and at least one minimum width which is less than either of said maximal widths, said first platform reaching said maximal widths at (a) the place where said first platform is adjacent to said third ridge, and (b) the place where said first platform is adjacent to the distal end of said first ridge, said first platform projecting at said maximal widths in the direction of said first well.

33. A holder according to claim 32, wherein said second ridge terminates in a distal end which is closer to the distal end of said first platform than to the proximal end of said first platform but which is spaced from said third ridge, said holder further comprising a second well which is formed in the holder in the region adjacent to the side of said first platform upon which said second ridge is located, and which extends to a depth below the level of said first platform;
said first platform being shaped so that, in the region of said first platform which is located between said third ridge and said distal end of said second ridge, said first platform reaches said maximal widths at (a) the place where said first platform is adjacent to said third ridge, and (b) the place where said first platform is adjacent to the distal end of said second ridge, said first platform further projecting at said maximal widths in the direction of said second well.

34. A holder according to claim 32, wherein said first hole is in fluid communication with a cavity defined in the body of said holder.

35. A holder according to claim 34, wherein the roof of said cavity is shaped so that the lowest point of said roof is along the edge where said cavity meets said first hole, and the perimeter of said cavity along said roof is higher than said edge where said cavity meets said first hole.

36. A holder according to claim 35, wherein along said edge where said cavity meets said first hole there is located a ridge which projects out from said roof of said cavity and which surrounds said first hole.

37. A holder according to claim 36, wherein at least one port, capable of receiving a plug therein, runs through the walls of said cavity to the exterior walls of said holder to allow said cavity to be in fluid communication with the outside.

38. A holder according to claim 37, wherein a plug is present in each port of said at least one port and the plugs collectively seal said cavity from said exterior walls of said holder.

39. A holder according to claim 34, wherein the floor of said cavity is shaped so that the highest point of the floor is aligned with said first hole, and the perimeter of said cavity along said floor is lower than said highest point of said floor.

40. (canceled)

41. A holder according to claim 32, wherein said uniform height is sufficiently low that when a cover slip is placed upon said first, second and third ridges so that said cover slip covers said first platform and a portion of said depression, liquid which is placed into said depression will move in the space between said cover slip and said platform in the direction of said third ridge by virtue of capillary forces.

42-53. (canceled)
